(19) United States
(12) Patent Application Publication
(10) Pub. No.: US 2019/0089713 A1
(43) Pub. Date: Mar. 21, 2019

(54) SYSTEM AND METHOD FOR PRODUCING A DYNAMICALLY ORDERED QUEUE

(71) Applicants: James J. Leftwich, Palo Alto, CA (US); Stephen S. Doss, Poulsbo, WA (US); Robert Masters, Ashmore (AU); Christine Satchell, Brighton (AU); Adrian G. Manning, Stanmore (AU)

(72) Inventors: James J. Leftwich, Palo Alto, CA (US); Stephen S. Doss, Poulsbo, WA (US); Robert Masters, Ashmore (AU); Christine Satchell, Brighton (AU); Adrian G. Manning, Stanmore (AU)

(21) Appl. No.: 16/134,546

(22) Filed: Sep. 18, 2018

Related U.S. Application Data
(60) Provisional application No. 62/560,091, filed on Sep. 18, 2017.
(60) Provisional application No. 62/565,434, filed on Sep. 29, 2017.
(60) Provisional application No. 62/586,118, filed on Nov. 14, 2017.
(60) Provisional application No. 62/632,365, filed on Feb. 19, 2018.

(51) Int. Cl. H04L 29/06; G06Q 30/06; G06Q 20/36; G06Q 20/12

(52) U.S. Cl. CPC H04L 63/104; H04L 63/0853; G06Q 20/123; G06Q 20/36; G06Q 30/0609

(57) ABSTRACT

A method includes instantiating, by one or more processors, a queue comprising a finite number of queuing slots configured to provide prioritized access to a host system, and receiving, by the one or more processors from devices associated with a plurality of requesting users, a plurality of queuing requests, each queuing request comprising information that identities a quantity of tokens. The method also includes allocating, by the one or more processors, at least a portion of the finite number of queuing slots to at least a portion of the requesting users according to the quantity of tokens identified by each queuing request, and authorizing, by the one or more processors, access to the host system in accordance with the allocation of the finite number of queuing slots.

### CROSS-REFERENCE TO RELATED APPLICATIONS

The present application claims the benefit of U.S. Provisional Application No. 62/560,091, filed Sep. 18, 2017; U.S. Provisional Application No. 62/565,434 filed Sep. 29, 2017; U.S. Provisional Application No. 62/586,118 filed Nov. 14, 2017; and U.S. Provisional Application No. 62/632,365 filed Feb. 19, 2018, each entitled “SYSTEM AND METHOD FOR PRODUCING A DYNAMICALLY ORDERED QUEUE.” The disclosures of these applications are all incorporated by reference herein in their entirety.

### TECHNICAL FIELD

The present invention relates to the field of managing system access and more particularly to systems and methods for implementing a dynamically ordered queuing model for controlling system access.

### BACKGROUND

Consumers obtain content, such as movies, music, games, and the like, in a variety of ways. For example, consumers may obtain media content in digital form (e.g., via download from a content distribution network (CDN)) or in physical form (e.g., a physical disc or other tangible form of media content). For certain types of content, choosing to obtain the content in digital form via download from a CDN may pose challenges. For example, when a new video game is released, the CDN from which consumers download the video game to their console or personal computer may become strained, resulting in slow download speeds. This may cause delays in obtaining the video game and, in extreme instances, causing the download to fail and/or requiring the download to be restarted.

As another example, streaming media services have gained popularity due to advances in technology capable of providing fast Internet speeds across a range of Internet-enabled user devices, such as mobile communication devices (e.g., smartphones), tablet computing devices, smart televisions, and the like. Despite the increased speed at which end user devices may access such streaming content over the Internet, surges of traffic caused by many users requesting to stream the same (or different) content simultaneously may cause the quality of the streaming content to be degraded, or may cause the stream to fail for some end users, resulting in an unsatisfactory experience for many end users. A good example of this is the boxing match between Floyd Mayweather and Conor McGregor, which was offered in traditional pay-per-view (e.g., via a cable distribution systems) as well as live-streaming over the Internet. The demand by consumers to watch the boxing match overwhelmed the systems designed to distribute the boxing match across the various viewing platforms, resulting in many of this systems needing to be rebooted, and causing a poor experience to many of the viewers. While the examples above highlight problems with traditional CDN-type content distribution systems, there are numerous other areas where there is high consumer demand for products (e.g., both digital and physical products) and/or services, but effective mechanisms to control access to the systems configured to manage distribution of and/or access to acquire those products and/or services are lacking, especially when initial access to acquire those products and/or services may experience large surges of activity by users attempting to acquire those products and/or services.

### SUMMARY

The present application is directed to systems and methods for providing a dynamically ordered queue configured to control access to a host system, where the host system is configured to provide users with access to one or more opportunities. In aspects, users may be allocated slots within the queue by submitting requests that identify a quantity of tokens. The tokens may be used to determine whether a requesting user is allocated a slot within the prioritized queue, and may also be used to assign a rank and/or position within the prioritized queue to users who are to be allocated a slot within the queue. In aspects, the ability to request allocation of a slot in the prioritized queue may be made available to all users for a period of time (e.g., a queuing period). Following an end of the queuing period, users that were allocated to slots of the prioritized queue may be given prioritized access to the host system in connection with an opportunity provided via the host system. In aspects, the host system may provide users assigned to slots of the queue with priority access to the host system in connection with the opportunity, where priority access enables those users to access the opportunity provided by the host system prior to a time period when users that were not assigned to a slot within the queue are provided access to participate in the opportunity available via the host system.

Embodiments may also facilitate rules governing the holding and sale of tokens identified in user requests. For example, such tokens may be escrowed by systems and, upon a user obtaining an allocated slot of a prioritized queue, a user's tokens may be placed on an open market for sale. Conversely, if a user does not obtain an allocated slot, their respective tokens may be refunded. Still further, in some aspects when tokes are placed on an open market for sale, such tokens may be placed on the market in a pre-determined priority. For example, the individual that has obtained the highest priority queue allocation may receive a higher priority token sale position (e.g. rights to sell first on the open market, or to specify the order of sale, etc.).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a block diagram illustrating aspects of a system configured to provide dynamic queuing in accordance with embodiments of the present disclosure;

FIG. 2 is a flow diagram illustrating aspects of a dynamic queue in accordance with embodiments of the present disclosure;

FIG. 3 is a flow diagram illustrating aspects of a method for providing dynamic queuing in accordance with embodiments of the present disclosure;

FIG. 4 is a flow diagram illustrating aspects of functional workflow for providing dynamic access queuing in accordance with embodiments of the present disclosure;

FIG. 5 is a block diagram illustrating additional aspects of a system architecture configured in accordance with embodiments of the present disclosure; and

FIG. 6 is a flow diagram of an embodiment of a method for implementing a crypto adoption turbine (CAT) process in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

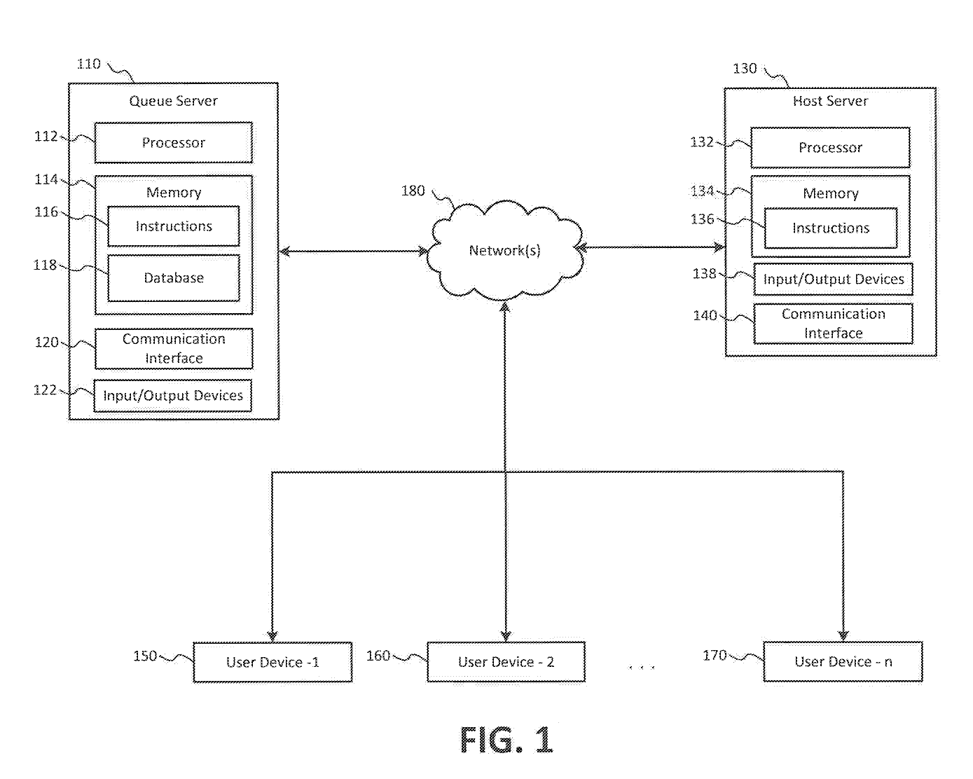

Referring to FIG. 1, a block diagram illustrating aspects of a system configured to provide dynamic queuing in accordance with embodiments of the present disclosure is shown as a system 100. As shown in FIG. 1, the system 100 includes a queue server 110 and a host server 150. It is noted that although queue server 110 and host system 130 are illustrated as single blocks, in aspects, each of queue server 110 and/or host system 130 may include a collection of devices, hardware, and software that are collectively configured to perform the operations described herein with respect to the queue server 110 and the host system 130. Additionally, it is noted that in aspects, queue server 110 and host system 130 may be integrated into a single device or collection of devices (e.g., a single server or set of servers) configured to implement functionality for providing the operations described herein as being provided by the queue server 110 and the host system 130, or may be realized as separate devices or collections of devices that are each configured to perform functionality of the queue server 110 or the host system 130.

The queue server 110 may include one or more processors 112, a memory 114, a communication interface 120, and input/output (I/O) devices 122. In aspects, the memory 114 may store instructions 116 that, when executed by the one or more processors 112, cause the one or more processors 112 to perform operations for managing a dynamically ordered queue in accordance with embodiments of the present disclosure, as described in more detail below. In aspects, the memory 114 may also store a database 118. In aspects, the database 118 may be stored external to one or more physical devices upon which functionality of the queue server 110 is implemented. For example, database 118 may be stored at a memory device that is accessible to the queue server 110 via a network. The communication interface 120 may be configured to communicatively couple the queue server 110 to one or more other systems, such as the host server 130, and networks according to one or more communication protocols (e.g., an institute of electrical and electronics engineers (IEEE) 802.11 protocol, an Ethernet protocol, and the like). The I/O devices 122 may include a printer, a mouse, a keyboard, a touchscreen display device, a numeric keypad, other types of input and output devices, or a combination thereof. As described in more detail below, the queue server 110 may be configured to generate a queue configured to provide priority access to host system 130 and to allocate slots of the queue to one or more users in accordance with aspects of embodiments of the present disclosure, as described in more detail below.

In aspects, the host server 130 may include one or more processors 132, a memory 134, a communication interface 140, and input/output (I/O) devices 138. In aspects, the memory 134 may store instructions 136 that, when executed by the one or more processors 132, cause the one or more processors 132 to perform operations for distributing an opportunity to one or more users based on a dynamically ordered queue in accordance with embodiments of the present disclosure, as described in more detail below. In aspects, the memory 134 may also store a database (not shown in FIG. 1). In aspects, the database of the host server 130 may be stored external to one or more physical devices upon which functionality of the host server 130 is implemented. For example, the database of the host server 130 may be stored at a memory device that is accessible to the host server 130 via a network. The communication interface 140 may be configured to communicatively couple the host server 130 to one or more other systems, such as queue server 110, and networks according to one or more communication protocols (e.g., an institute of electrical and electronics engineers (IEEE) 802.11 protocol, an Ethernet protocol, and the like). The I/O devices 138 may include a printer, a mouse, a keyboard, a touchscreen display device, a numeric keypad, other types of input and output devices, or a combination thereof.

As shown in FIG. 1, the queue server 110 and host server 130 may be communicatively coupled to n user devices, such as a first user device 150, a second user device 160, and an nth user device 170, via a network 180. During operation, the queue server 110 may instantiate a queue in connection with an opportunity offered to the plurality of users by the host system 130. In aspects, the opportunity may correspond to an opportunity to purchase at least one of a product and a service. In aspects, the products may include physical items (e.g., books, digital video discs (DVDs), clothes, and the like) and/or digital assets (e.g., digital music files, digital movie files, blockchain ledger-based coins, and the like). In aspects, the queue may include a finite number of queuing slots configured to provide prioritized access to the host system by users assigned to each of the queuing slots. In aspects, a queuing period may defined, and during the queuing period, users may submit requests to receive an allocation of one of the queuing slots within the queue. For example, the queuing period may be defined as a one week period of time prior providing queued access to the host server 130 in connection with an opportunity, and during the queuing period users may request to be allocated to one of the queuing slots of the queue. In aspects, the number of queuing slots within the queue may be finite. In aspects, different queues created by the queue server 110 may have different numbers of queuing slots. For example, a first queue associated with a first opportunity may have a first number of slots, and a second queue associated with a second opportunity may have a second number of slots, where the first and second numbers of slots are different.

During the queuing period, the queue server 110 may receive a plurality of queuing requests from the plurality of user devices, such as user devices 150-160. In aspects, each queuing request may include information that identifies a quantity of tokens. In aspects, the tokens may correspond to tokens offered for sale by an operator of the queue server 110, and the tokens may be created for the purpose of allowing users to compete for slots within queues created by the queue server 110 in connection with one or more opportunities. For example, the queue server 110 may generate a plurality of tokens, and then users may purchase a quantity of the generated tokens. Once a user has acquired a quantity of tokens, the user may submit a request to enter a queue generated by the queue server, where the request identifies at least a portion of the tokens acquired user. The value of the tokens may be initially set by an operator of the queue server 110. However, in aspects, the value of the tokens may fluctuate with time and market conditions. For example, as demand for the tokens grows, the value of the tokens may increase, and, if demand for the tokens weakens, the value of the tokens may decrease. In aspects, the tokens may be generated using blockchain distributed ledger technology. For example, in aspects, the tokens generated and distributed by the queue server 110 may be generated according to the Ethereum ERC20 Token Standard. Generating the tokens using blockchain distributed ledger technology may be advantageous. For example, such an implementation would create immutable records of token ownership.

As the queuing requests are received by the queue server 110 from the plurality of users, the queue server 110 may be configured to allocate at least a portion of the queuing slots to the requesting users. In aspects, the queue server 110 may be configured to allocate users to the slots of the queue according to the quantity of tokens identified by each user in their queuing request. For example, if a queue having 10 queuing slots was created by the queue server 110, and 12 different users submitted requests to be allocated to the queue, only 10 of the users could actually be allocated to the queue, resulting in 2 users not being allocated to the queue. As another example, if only 8 different users submitted requests to be allocated to the queue, all 8 of the users would be allocated to the queue, and two queuing slots would remain available in the queue. In aspects, the queue server 110 may be configured to validate the quantities of tokens identified in each of the queuing requests prior to allocating slots to any particular user, such as to validate that the user actually owns the quantity of tokens identified in the queuing request. This prevents a user from identifying a quantity of tokens that is larger than the quantity of tokens actually owned by the user from being allocated to a slot, only to have to remove the user from the queued slot at a later time when it is discovered that the user owns less tokens than they had represented in their request.

In aspects, the queue server 110 may be configured to generate notifications regarding the status of each user's request for allocation of a queuing slot. For example, where a user is allocated a queuing slot within the queue, the queue server 110 may generate and transmit a notification to the user to indicate the particular slot (e.g., “You have been allocated to slot ‘x’ in the queue”), and where the user is not allocated a queuing slots within the queue, the queue server may generate and transmit a notification to the user to indicate the quantity of tokens identified in the user's request was insufficient to allocate the user to a slot of the queue (e.g., “Your designation of ‘y’ tokens was insufficient to receive an allocation of a slot within the queue”). In aspects, the notifications generated by the queue server 110 may include additional information, such as information to indicate a threshold quantity of tokens required to be assigned a slot within the queue (e.g., “At this time, the minimum quantity of tokens to receive an allocation of a slot within the queue is ‘z’ tokens”, where “z” tokens is greater than the amount of tokens identified in the request of the user allocated to the last slot of the queue), information regarding an amount of tokens required to move up to a higher slot within the queue (e.g., “If you would like to move from slot 5 within the queue to slot 4, ‘a’ additional tokens is required”, where “a” additional tokens+“b” tokens is greater than the quantity of tokens identified in the request associated with the user currently allocated to slot 4), information that indicates a user's allocation with the queue has changed (e.g., “You have been reallocated to slot ‘c’ within the queue due to recent queuing activity”), or other types of notification messages configured to provide the users with an understanding of recent activity by the queuing server 110. In aspects, the notifications may be provided via a web interface, such as a graphical user interface of a website configured to provide users with access to the queue server 110. In aspects, the graphical user interface may be provided as a mobile application executing on the user's mobile device, an application executing on the user's desktop, laptop, or tablet computing device, or another type of application executable by one or more processors. In aspects, the notifications may additionally or alternatively be provided via short messaging server (SMS) messages or another type of messaging service, such as push notifications provided to the user's mobile device.

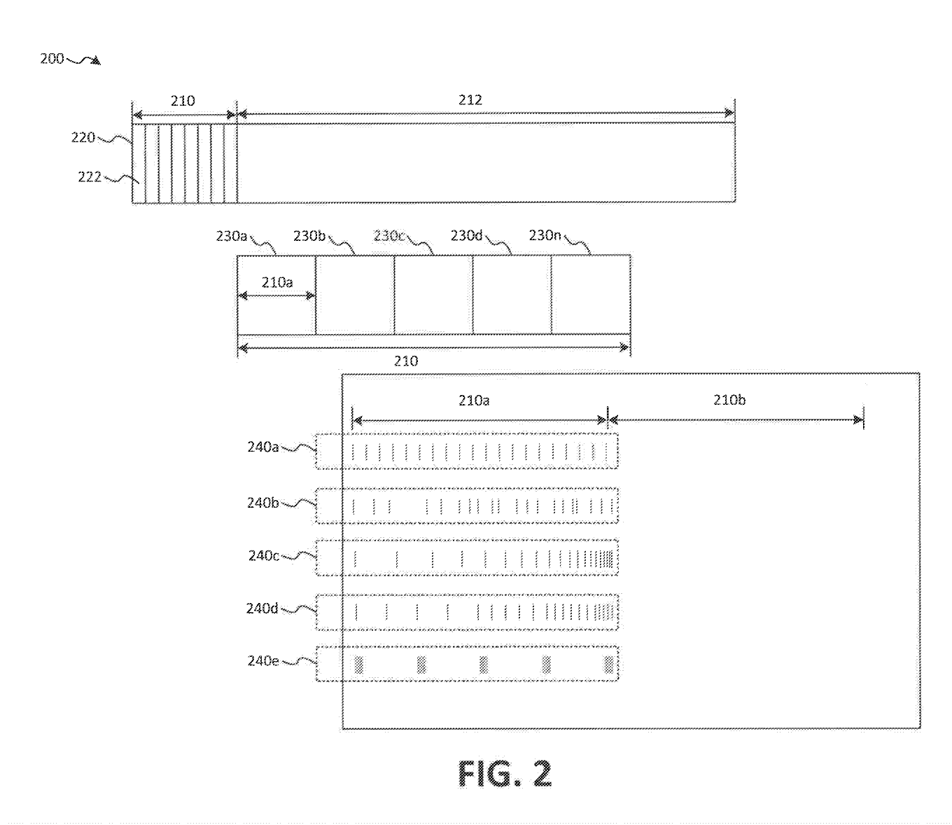

After the queuing period has ended, users may be may be authorized to access the host server 130 in accordance with the allocation of the queuing slots of the queue. For example, and referring to FIG. 2, a flow diagram illustrating aspects of a dynamic queue in accordance with embodiments of the present disclosure is shown as a dynamic queue 200. As shown in FIG. 2, users have been allocated to slots 222 of a queue 220, and the users who are allocated within a queue 220 may be provided with access to the host system 130 during a first period of time 210, and following access by the queued users, all users may be provided with access to the host system 130 during a second period of time 210 (e.g., an open access period). In aspects, providing access to the host system 130 in accordance with the queue may occur in a variety of ways. For example, in aspects, during the first period of time 210, all users allocated to slots within the queue may be provided with access to the host system 130, and all other users (e.g., all users that were not allocated to a slot within the queue) may be restricted from accessing the host system 130. Thus, during the first time period, the queued users may have prioritized access to the host system 130, and during this prioritized access, these users may be able to participate in an opportunity offered by the host system 130, as described above.

In aspects, once all users have been allocated to the queue and the queuing period has ended (e.g., the queue is no longer accepting changes), the queue may be divided into a plurality of subgroups. For example, as shown in FIG. 2, in aspects, queued users may be assigned into one of n queue groups, shown in FIG. 2 as queue groups 230a, 203b, 230c, 230d, 230n. It is noted that although 5 queue groups are shown in FIG. 2, in aspects, a group of users allocated to slots within a queue may be grouped into more than 5 or less than 5 queue subgroups. Thus, the present disclosure is not to be limited to any particular number of queue subgroups. Once the users have been allocated to a particular queue subgroup, access to the host system 130 may be authorized on a per-queue subgroups basis. For example, users associated with queue subgroup 230a may be authorized to access the host system 130 prior to users associated with queue subgroups 230b-230n, and users associated with queue subgroup 230b may be authorized to access the host system 130 after users associated with queue subgroup 230a, but prior to users associated with queue subgroups 230c-230n. By assigning users to subgroups, access to host system 130 may be further restricted, which may improve the performance of the host system 130 during access by each of the subgroups.

In aspects, access to host system 130 by queued users may also be restricted based on time. For example, as shown at 240a, the first period of time 210 may be divided into further subperiods of time 210a, 210b, etc. Each subperiod of time may be allocated to different subgroups of the allocated users. For example, the subperiod of time 210a may be allocated to providing access to host system 130 by subgroup 230a, subperiod of time 210b may be allocated to providing access to host system 130 by subgroup 230b, and so on.

Further, users within a particular subgroup may also be provided with varying access to host system 130. For example, in aspects, within the subperiod of time 210a, access to host system 130 by users associated with the first subgroup 230a may be restricted to various time slots, as shown at 240a-240e, where 240a illustrates an evenly spaced time slot configuration, 240b illustrates a first proportionately distributed time slot configuration, 240c illustrates a geometrically distributed time slot configuration, 240d illustrates a second proportionately distributed time slot configuration, and 240e illustrates an evenly spaced sub-subgroup time slot configuration in which a subgroup is further divided into sub-subgroups and each sub-subgroup is assigned to one of many evenly spaced time slots. It is noted that although restricting access to host system 130 based on time has been described with reference to subgroups, aspects of the present disclosure should not be so limited. As will be readily understood from the present disclosure, the concept of restricting access to host system 130 based on the various time slot configurations 240a-240e could be readily applied to the entire queued user base (e.g., as an alternative to dividing the queued user base into subgroups).

After the first time period 210 has ended, all users may be provided with access to the host system 130, as shown at time period 212, also referred to herein as an open period, meaning that access to the host system 130 is not restricted to particular users, such as the queued users. Thus, even though a particular user may have accessed host server 130 to participate in the opportunity during the first period of time 210, the particular user may subsequently access the host server 130 again during the open period 212 to further participate in the opportunity if desired.

Referring back to FIG. 1, in aspects, once the queue is finalized, the queue server 110 may execute a series of transactions to transfer ownership of the quantities of tokens identified in each of the requests received from the users allocated to the slots of the queue from the users to the operator of the queue server 110. By refraining from executing transactions to transfer ownership of the tokens until after the queuing process is finalized, no transactions need be initiated or executed for users that submitted queuing requests but did not receive an allocation of a slot within the queue.

In aspects, when determining whether to allocate particular users to slots of the queue, the queue server may determine whether a quantity of tokens identified in each received queuing request satisfies a threshold quantity of tokens. In aspects, the threshold quantity of tokens may be associated with a variable quantity of tokens, where the quantity of tokens associated with the threshold quantity of tokens increases over time. For example, when initially established, the threshold quantity of tokens may be small, such as some pre-determined minimum quantity of tokens established by the operator of the queue server 110. However, as users submit requests, the quantity of tokens associated with the threshold may increase. This is because a user who submits a request identifying a first quantity of tokens may not receive an allocation of a slot within the queue, which may prompt the user to submit another request indicating a higher quantity of tokens. If this higher quantity of tokens is greater than the quantity of tokens that was identified in the request submitted by the user currently allocated to the last slot within the queue, the last slot in the queue may be reallocated to at least the last slot in the queue. If the higher quantity of tokens is sufficient to place the user further up in the queue, other queued users may be downgraded or allocated to lower slots in the queue and the last user may be removed from the queue. As explained above, as the queuing process takes place, the queue server 110 may generate notifications to the various users to indicate a current status of the queue and/or their particular allocated slot within the queue.

In aspects, the opportunity provided by the host system 130 may be restricted to a particular amount during the access provided to the users of the queue. For example, if the opportunity provided by the host server 130 is related to the sale of a particular product, a threshold quantity of the product may be reserved for acquisition by the requesting users during the first period of time (e.g., the first time period 210), and a remaining quantity of the product may be reserved for acquisition by all users during the second period of time (e.g., the open period 212). In this manner, users desiring to guarantee access to the opportunity may obtain prioritized access to the opportunity, while still allowing a sufficient number of users the opportunity to participate in the opportunity during the open period.

In aspects, access to the host system 130 may provide an improved quality of service to users allocated to the slots of the queue. For example, in aspects, the host server 130 may correspond to a server of a content distribution network, and prioritized access to the host server 130 by the requesting users allocated to one of the queuing slots may enable the queued users to initiate a download of content prior to other users. In aspects, the host server 130 may be configured to provide a prioritized connection to those users that were allocated to slots of the queue so that if a spike in traffic is experienced by the host server 130, the connections by the queued users are prioritized, reducing a likelihood that those users experience degraded quality of service. Streaming services may be similarly prioritized.

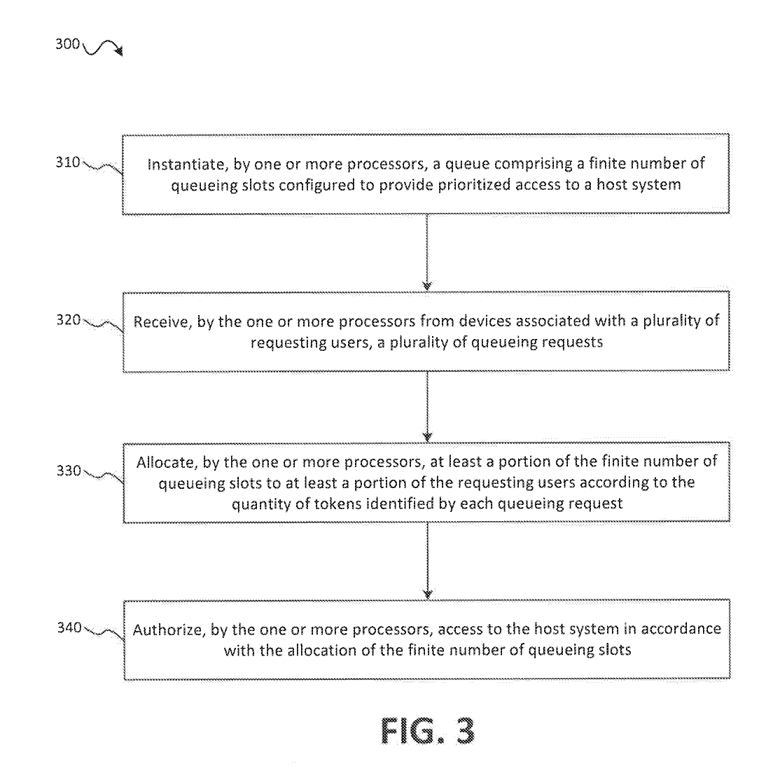

Referring to FIG. 3, a flow diagram illustrating aspects of a method for providing dynamic queuing in accordance with embodiments of the present disclosure is shown as a method 300. In aspects, the method 300 may be implemented as instructions stored on a computer-readable storage medium that, when executed by one or more processors, such as the one or more processors 112 of FIG. 1, cause the one or more processors to perform operations of the method 300 in accordance with embodiments of the present disclosure. As shown in FIG. 3, the method 300 includes instantiating at 310, by one or more processors, a queue comprising a finite number of queuing slots configured to provide prioritized access to a host system. In aspects, the queue may correspond to the queue described above with reference to FIGS. 1 and 2, and may be instantiated by the queue server 110 of FIG. 1 or the host system 130 of FIG. 1. As described above with reference to FIGS. 1 and 2, the queue may be configured to provide priority access to a host system, such as the host system 130 of FIG. 1.

At 320, the method 300 includes receiving, by the one or more processors from devices associated with a plurality of requesting users, a plurality of queuing requests. In aspects, each queuing request comprises information that identifies a quantity of tokens. As described above with reference to FIGS. 1 and 2, in aspects, the quantity of tokens may serve as a bid by a particular requesting user, where the bid requests allocation of the particular requesting user to one of the slots of the queue. In aspects, the queuing requests may be received during a queuing period, and all users may submit queuing requests during the queuing period. However, it is understood that depending on the size of the queue, not all users that submit queuing requests will be allocated to a slot of the queue.

At 330, the method 300 includes allocating, by the one or more processors, at least a portion of the finite number of queuing slots to at least a portion of the requesting users according to the quantity of tokens identified by each queuing request. As described above with reference to FIGS. 1 and 2, as queuing requests are received, the number of tokens identified in each of the queuing requests is analyzed to determine whether the requesting user corresponding a particular queuing request has bid (e.g., identified within the queuing request) a sufficient number of tokens to be allocated a slot within the queue. As described above, in aspects, a requesting user may initially submit a request that identifies a sufficient quantity of tokens to be allocated a slot within the queue, but may be subsequently removed from the queue based on quantities of tokens identified in subsequently received queuing requests. In such instances, one or more notifications may be generated, as described above, to notify the requesting user that they have been removed from the queue. If a requesting user is removed from the queue, the user may submit another queuing request identifying a larger quantity of tokens, and, if the larger quantity of tokens is sufficient to allow the requesting user to be allocated to a slot within the queue, the user may receive a subsequent notification that the user's second queuing request has cause the user to be allocated a slot within the queue. As described above, the particular order in which users are allocated to the slots within the queue may reflect a quantity of tokens that each user identified in their associated queuing request, with the highest quantity of tokens receiving the first slot within the queue, and the lowest number of qualifying tokens (e.g., the smallest amount of tokens identified in a queuing request for which a slot in the queue was allocated) receiving the last slot in the queue.

At 340, the method 340 includes authorizing, by the one or more processors, access to the host system in accordance with the allocation of the finite number of queuing slots. As described above with reference to FIGS. 1 and 2, in aspects, authorizing access to the host system may include grouping the users allocated to the slots of the queue into one or more subgroups, and then providing access to the host system to higher priority subgroups before lower priority subgroups. In aspects, rather than, or in addition to, dividing the queued users into subgroups, users may individually be prioritized according to a access hierarchy. The access hierarchy may provide ordered access to the host system by the queued users, where users ranked higher in the hierarchy receive access to the host system before lower ranked users within the queue. In aspects, tiers between different users and/or groups may be provided access to the system at varying intervals of time. For example, in aspects, each group may be given the same amount of time for which to access the host system, such as each group and/or user has exclusive access to the host system for “X” amount of time (e.g., days, minutes, hours, etc.), and after the expiration of the amount of time for a first user or group, a second user or group is provided exclusive access to the host system for “X” amount of time. In some aspects, the amount of time may be different for different users and/or subgroups of users. For example, a first user and/or subgroup may be provided with exclusive access to the host system for a first amount of time, and a second user and/or subgroup may be provided with exclusive access to the host system for a second amount of time, where the second amount of time is shorter than the first amount of time, as explained above with reference to FIGS. 1 and 2. Once all users allocated to slots of the queue have been provided with access to the host system based on the queue, access to the host system may be made available to the public.

By providing access to the host system in accordance with aspects of embodiments of the present disclosure, bottlenecks associated with surges of users requesting access to the host system may be avoided and/or reduced. Additionally, using the dynamically ordered queuing techniques of embodiments, distribution of access to opportunities may be provided in a more orderly manner while ensuring that at least a portion of the opportunity is made available to the general population of users.

Various examples of how the embodiments disclosed herein may be applied are described below. It should be noted that these examples are provided to illustrate the diverse number of situations to which the above-described embodiments may be applied, and are therefore not to be deemed as limiting the present disclosure.

Suppose that a company is releasing a new coin using blockchain distributed ledger technology, a process commonly referred to as an initial coin offering (ICO). The company may define a pre-opportunity access queuing (OAQ) period, which is a period of time during which users may submit requests to be allocated to slots within the queue. A queue configured to provide access to a host system, such as a system that enables the queued users to participate in the ICO by purchasing quantities of the new coin, may be instantiated, and, as queuing requests are received, the users may be allocated to slots within the queue based on the quantity of tokens identified in each of their queuing requests. It is noted that not all users that submit a queuing request may receive an allocation of a slot within the queue, however, these users may subsequently participate in the ICO during an open period, in which the host system is made available to all users that wish to participate in the ICO. In aspects, the host system may be a third party with respect to the company that is offering the ICO. In aspects, the host system may be operated by the company that is offering the ICO.

As described above, the host system may be configured to limit the quantity of the coin offered during the priority access period (e.g., the period of time during which queued users are provided “early” access to purchase the new coin). In aspects, the quantity may be restricted based on percentage of coins/tokens set aside for access during the first time period (e.g., the time period 210 of FIG. 2). Additionally, other restrictions may be applied, such as restrictions associated with any additional benefits, preferred attributes or advantages that queued users may be given subject to the ICO's Terms Of Service.

As described above, the more tokens that a user identifies in his/her queuing request, the higher/earlier their reserved place within the queue may be. In aspects, the queue may be divided into subgroups, as described above. And within OAQ Groups, individual members can be assigned ordered “Green Light” starts when they can begin their participation in the associated offered opportunity transaction, such as purchasing/acquiring coins in an ICO. In aspects, additional conditions may be applied to the queuing and/or the ICO opportunity to support incentives or limitations.

The established dynamic opportunity queue (DOQ) may serve to aid in the management of traffic rushes which have been problems for some popular ICOs to date, as well as provide a solid basis for building value in the underlying token used by users to obtain positioning and/or rank within the DOQ.

Using the DOQ model disclosed herein, a system and methodology is provided that produces the OAQ, which may be a group and/or queue giving member individuals and entities favored access to offered opportunities, separate from any subsequent and additional transaction to participate in purchasing and/or otherwise acquiring the offered opportunity itself

Example 1: A person spends a number of tokens as bids during queuing period (a pre-OAQ period) in order to obtain an ordered place in a queued group to purchase tokens in an Initial Coin Offering (ICO). Those users spending higher amounts of tokens may obtain earlier places in the queued group.

Example 2: A person pledges a number of tokens during the queuing period (a Pre-OAQ period) in order to try to obtain an ordered place in a limited-number group to purchase one of the first new manufactured vehicles by an automobile manufacturer. Of all the individuals that pledged during the pre-OAQ period sorted from those that pledged the most to those that pledged the least, the number users that offered the highest quantity of tokens equal to the number of places in the limited opportunity will be included in the OAQ and their tokens accepted as payment (e.g., for entry into the OAQ), and they will be able to spend fiat currency (or whatever the terms of the opportunity's transaction is) to then purchase one of the available vehicles. Those users that were not included in the OAQ will retain their tokens (or have them refunded).

In aspects, systems implementing the DOQ model of embodiments may be made widely applicable and may be licensed for use in a wide range of uses and applications, such as situations where it may be advantageous or valuable to offer a means to obtain special early access or other types of benefits in conjunction with an offered opportunity. In aspects, the tokens used to secure a slot in the OAQ may have a market-based value and may be bought and/or traded. In some aspects, the tokens may be parked/invested in a secondary coin/token market. In aspects, tokens used to acquire access to the OAQ may provide a means to obtain a place in line (a queue) for an offered opportunity, as described above, and may take a variety of forms and embodiments of ordered and/or grouped access to opportunities, including but not limited to examples such as items, services, upgrades, special offers, properties, assets, designations, privileges, accessibility or anything that can be limited in nature, and/or ordered in a first place to last place manner and/or further divided into groupings. Such OAQs may be used for special pre-open-to-anyone offering periods that precede entirely, overlap partially with, or coincide entirely with non-OAQ, non-preferred, open-to-anyone, and/or open-to-an-expanded-group access to an offered opportunity.

Such offered opportunities can be anything, including, but not limited to, an opportunity to be one of the first purchasing owners of a newly released product, or an opportunity to be among the first purchasing ticketholders for a premiere movie, or obtain a favored seat in an exclusive section of an event. In the example of an ICO (initial Coin Offering), an OAQ can be an early ICO period, open only to OAQ members, or it may represent a special class of ICO participants eligible for or receiving special offers, upgrades, or other types of benefits.

One aspect of tokens and the DOQ model is that it may not, in and of itself, be used for a purchase of an end product, service or offering, at least in some embodiments. Instead, it may serve as a means of obtaining a place in a line or group in which to further and separately transact or interact to obtain the offered opportunity. Spending/redemption usage of tokens may be specifically and only associated with obtaining a place in line or queue, and may, in some aspects, not be a means to purchase or obtain the offered opportunity itself. The resulting OAQ that may be created represents a special privileged or benefited category of users with access to an associated later or concurrent access opportunity available to a wider group of participants.

In aspects, an OAQ may also include the totality of an offered opportunity, such that only individuals or entities participating in the pre-OAQ period and successfully obtaining a membership in the OAQ may have access to the offered opportunity and there will be no non-OAQ access to the offered opportunity.

Opportunities themselves, which may employ OAQs in accordance with aspects of the present disclosure, may set their own independent acquisition criteria completely separate from any DOQ method-derived OAQ and token associated with obtaining membership in the associated OAQ. As such, an offered opportunity may itself be free, or have separate associated acquisition costs, which could include such cost types as purchase price, rental or leasing costs, or other compensational, trading, bartering or consideration terms and/or arrangements.

During queuing periods, owners/holders of tokens may be able to spend/redeem the tokens as accumulative bids for places in OAQs. During the queuing period, the owners/holders can bid tokens (or, optionally as allowed, fractional percentages of tokens) as much and as often as they like, with their total spend/bid accumulatively totaled and ranked in order among all other participants in the associated OAQ.

During a queuing period, the overall ranking of participants may be periodically updated and displayed publicly. In aspects, this may simply identify a particular users place in the process, such as whether the user has been allocated a slot within the OAQ. In some aspects, this may further include displaying a dynamically updated list of the entire OAQ, such as displaying each slot in the OAQ and the corresponding quantity of tokens associated with each slot. In aspects, names and other confidential information may not be shown for privacy purposes. In some aspects, nicknames or psuedo-names may be used to protect the users' privacy. The frequency of this update can be live in real time (e.g., accurate to within few seconds), or may be adjusted to balance current ranking feedback to participants with a level of uncertainty aimed at maximizing excitement and increased participation.

In aspects, the queue server 110, the host server 130, or both, may offer additional rewards for certain rank positions. For example, a house may be given to the user awarded the top slot in an OAQ, a car to the holder of the second slot, and the like.

As briefly explained above, in order to avoid the DOQ model from “running away” with all the opportunities in an opportunity, two mechanisms may be utilized. The first is that tokens must be spent/bid in order for an owner/holder to obtain ranking within the OAQ. As such, large-scale owners/holders of tokens may be able to exercise great advantage, but that advantage will only hold as long as they own/hold large numbers of tokens. Secondly, the percentage of any opportunity made available during or through the OAQ can and may be limited. For example, in the case of applying the model to an ICO, the opportunity offered (the ICO owner) may set aside 20% (or 25%, or 35%, etc.) of the total token/coin offering to be available to users within the OAQ, leaving the remainder as accessible in an open period. Furthermore, an opportunity offered may allow OAQ members to also participate in such a non-OAQ, open period, or they may not allow or place restrictions upon OAQ members that participated in the OAQ period during the subsequent (or concurrent) non-OAQ open period.

As explained above, during an OAQ period, the OAQ members may be divided into two or more OAQ Groups. Opportunity offerors may make the OAQ leader (e.g., the single individual or entity that spent the most tokens during the Pre-OAQ Bidding Period) a single group, or may want to combine certain percentages into respective groups. Group structures may be flexible and configurable by the opportunity offered.

One potential embodiment of an OAQ group structure may be as follows in conjunction with an ICO:

The entire number of OAQ participants are ordered from the highest spender/accumulative bidder to the lowest spender/accumulative bidder. This ordered set is then divided into five groups, each representing successive 20% increments, producing a five-level OAQ Group Structure as such:
OAQ Group 1: Top 20% Highest Spenders/Accumulative Bidders of tokens in the Pre-OAQ Bidding Period
OAQ Group 2: 21.99%-40% Highest Spenders/Accumulative Bidders of tokens in the Pre-OAQ Bidding Period
OAQ Group 3: 41.99%-60% Highest Spenders/Accumulative Bidders of tokens in the Pre-OAQ Bidding Period
OAQ Group 4: 61.99%-80% Highest Spenders/Accumulative Bidders of tokens in the Pre-OAQ Bidding Period
OAQ Group 5: Bottom 81%-100% Spenders/Accumulative Bidders of tokens in the Pre-OAQ Bidding Period

In an example where such an OAQ period will precede a regular open ICC period, OAQ Group 1's period might begin on Sep. 30, 2017 at 09:00 GMT and run until Oct. 1, 2017 at 9:00 GMT, when OAQ Group 2's period may commence, and so on each twenty-four hours until all of the prioritized OAQ Groups have had their opportunities and the open period of the ICO begins. In such a configuration, the OAQ period may last five days total prior to the beginning of the open period.

These OAQ Groups may be comprised those OAQ members (e.g., individuals and/or entities) with early access to participate in the ICO. For simplicity and ease of participant understanding and orientation, assume that these five OAQ Groups correspond with five days prior to a regular, open-to-all OAQ Group 1 will open five days prior, OAQ Group 2 will open four days prior, etc. through OAQ Group 5, which will open the day before the regular, open-to-all ICO.

As stated above, within any particular OAQ Group, individual members/entities may have specific rankings which may be queued and “Green Lighted” for actual participation. Like the option of having OAQ Groups, green light starting positions may also be used in a system implementing the DOQ model of embodiments. Green lighting may provide a means to space out and manage incoming access to an opportunity, as described above with reference to FIG. 2. In the ICOs held to date, there have been some that have had online server crashes as many participants have attempted to come in simultaneously, overwhelming the capacity of the servers and their ability to accommodate requests.

Once the group period begins, members of OAQ Group 1 may have an “Open Status” turned on, but their individual “Green Light” Signals (indicating that they can begin purchasing) may be staged according to individual ranking, as described above with reference to FIG. 2. This green light staging may completely play out within a group in the span of an hour, or over four hours, etc. Exact time of green lighting on a per user basis may be known/made available to OAQ members, and may be configurable. Given the historic runs on ICOs, individual green lights may be run very quickly, as it may only take a few seconds for somebody to buy a large percentage.

As the number of individuals/entities in any OAQ Group may vary, and may involve large numbers of members, this operation may be based on calculating a total OAQ Group green lighting period. In aspects, each period may take place over one hour, or 1/24th of a whole OAQ group period. During a one hour long OAQ Group green lighting period (e.g., 60 minutes/3,600 seconds) members assigned to that group may be queued to be individually green lighted in the order of their intra-Group ranking order.

Types of OAQ Green Lighting include, but are not limited to, the following OAQ Group members/green lighting timing distribution configurations:
An evenly distributed timing (i.e.: Total Green Lighting Period divided by number of members)
A proportionately distributed timing (i.e.: Total Green Lighting Period divided by number of members, with each member's Green Light starting proportionately to their proportionate ranking order within all members of their respective OAQ Group). This model may further incentivize members of any group to hold proportionately more tokens and correspondingly gain more time before others were Green Lighted.
Owners/holders of tokens that spend/bid their tokens to obtain places in OAQs may earn additional credits or tracked points towards secondary rewards or opportunities.

The operator of the queue server 110 and/or the host server 130 may incorporate additional mechanisms, such as random drawings and/or other models for advancing individual participants within OAQs, such as randomly selecting one or more OAQ members for moving to a more favored (higher) ordered position, or award randomly or systematically award or bestow other benefits, prizes, items, services, upgrades, special offers, properties, assets, designations, privileges, accessibility, etc. Such mechanisms and methodologies may be used to more widely distribute benefits, in turn increasing overall interest and excitement in the system and subsequently enhancing its overall value.

Favorable queue weighting may be given to earlier pledges/spends during a pre-OAQ period.

Favorable queue weighting may be given to token pledges/spends based on the length of time the token owner/holder has owned/held the tokens.

The formulas below provide exemplary expressions that may be used by the a server configured to implementing dynamically ordered queues in accordance with embodiments of the present disclosure:
Unordered Inclusionary Group of OAQ Members

o:={i₁(s), i₂(s), i₃(s), . . . , i₁(s)}
Simple Ranked Order Queue of OAQ Members

p:32 {i₁(s)>, i₂(s)>, i₃(s)>, . . . }
Proportionately Ranked Order Queue of OAQ Members

p:={i₁(s)f(s/t)>, i₂(s)f(s/t)>, i₃(s)f(s/t)>, . . . }

In the expressions above, o represents the Opportunity Access Queue (OAQ), i represents a participating individual or entity, s represents a subtotal of tokens spent by each individual, t represents the total tokens spent by everyone, p represents a place in the OAQ, and l represents a limit of available OAQ places or last OAQ place.

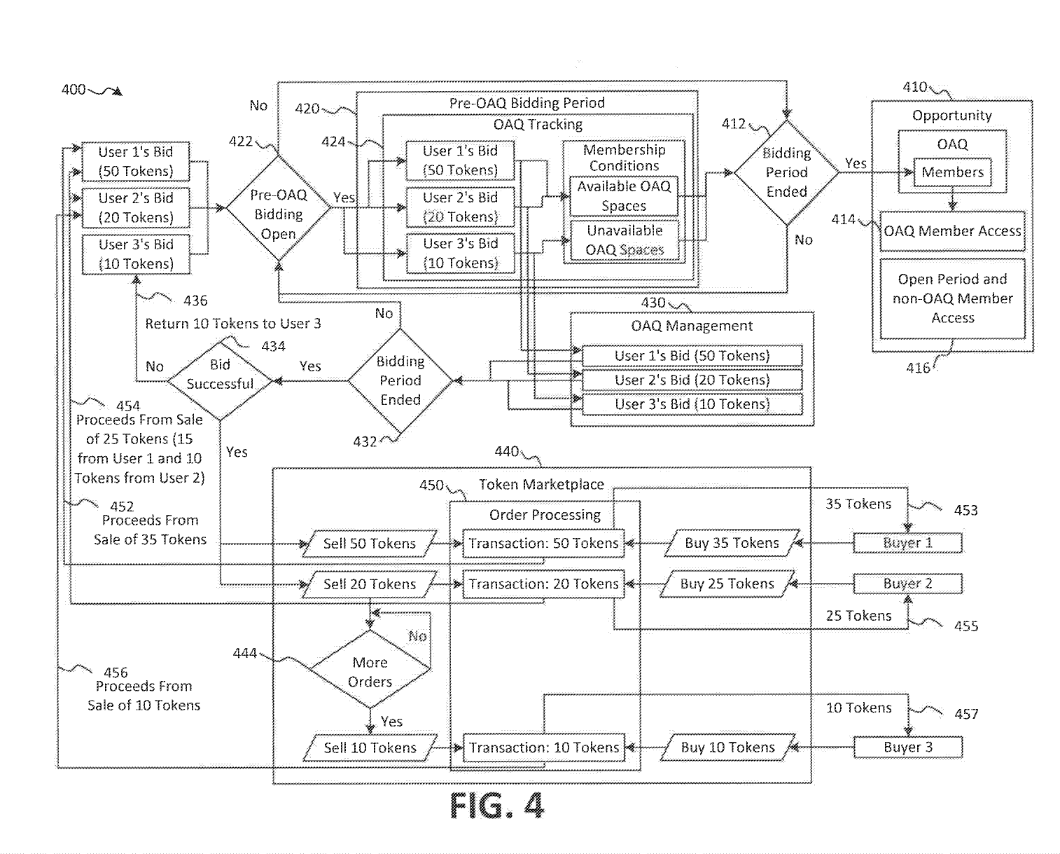

Referring to FIG. 4, a flow diagram illustrating aspects of a method for providing a recirculatory utility token recycling model with dynamic access queuing in accordance with embodiments of the present disclosure is shown as a method 400. In an embodiment, the method 400 may be implemented by an OAQ platform, such as the system of FIG. 1. For example, operations of the method 400 may be stored as the instructions 116 that, when executed by the one or more processors 112, cause the one or more processors 112 to perform the operations of the flow 400, as described in more detail below. In an embodiment, tokens utilized by the OAQ platform may be buyable, salable, and exchangeable independent of usage within the OAQ platform. As described in more detail below, in an embodiment, the method 400 may implement a recirculatory utility token recycling model in which use of the tokens within the OAQ platform will constitute a commitment of tokens associated with successful bids to sale/exchange, and the bidder may have little or no control over the parameters of the sale. The bidder will then receive at least a portion of the proceeds of that sale, and this will be secondary to what the bidder obtain through the use of the token in its associated bid.

As shown in FIG. 4, an opportunity 410 may be defined. The opportunity may be defined via an interface provided via a website, a standalone application, or another medium, such as one or more calls to an application programming interface (API) of a server implementing an OAQ architecture in accordance with embodiments of the present disclosure. At the defining stage, the entity offering the opportunity 410 may specify a configuration of an OAQ module for providing the opportunity 410. The configuration of the OAQ module may include various terms of the opportunity 410, such as parameters for an OAQ bidding period (e.g., a period of time when users may submit bids for assignment into the OAQ, a duration of the OAQ bidding period, a start date and time when the OAQ bidding period is to begin, an ending date and time when the OAQ bidding period will close, and the like); a number of available spaces within the OAQ; a minimum bid, if any, required for assignment into the OAQ; a description of the opportunity 410; whether the OAQ will utilize OAQ groups, and, if OAQ groups are utilized, information for defining parameters for the OAQ groups; information indicating whether the OAQ will be limited or unlimited; OAQ member access parameters, OAQ structured green lighting parameters; other parameters; or a combination of these parameters.

The duration, as well as the starting and ending dates and times of the pre-OAQ bidding period, may specify a period of time during which token owners can bid tokens in hopes of successfully becoming OAQ members for the opportunity 410. No tokens may be bid prior to the beginning of the pre-OAQ bidding period, and after it ends, the final OAQ membership and ranking order may be finalized and no more tokens may be bid. In addition to establishing the duration and start and end times for the pre-OAQ period, the configuration of the opportunity 410 may define the starting and ending dates and times of the OAQ period itself. This will configure when the OAQ for the offered opportunity will officially begin for OAQ members (e.g., when the OAQ members will gain access to the opportunity 410). In some situations, the OAQ period may have a beginning date, but remain open indefinitely with no closing date, or may have a closing date that to be established later, such as in the case where the offered opportunity itself is a bidding auction where at some point there will be a winner and the opportunity is subsequently closed or ended. In other situations, the OAQ period may have a defined end date and time, such as where the OAQ period provides the OAQ members with early access to the opportunity 410, and then, following the end date of the OAQ period, the opportunity 410 may be made available to the public, as described above.

The description of the opportunity 410 may describe the opportunity that the OAQ will be associated with. For example, the description may indicate that the OAQ provides members with access to an early buying round in an ICO, access to purchase one of limited number of new exotic automobiles, access to purchase exclusive or limited seating at an event (e.g., a sporting event, a concert, and the like), access to an opportunity to purchase a condominium in a new tower building, or a home in a residential development, or other types of opportunities. The description of the opportunity 410 may also include additional information, such as what the price or nature of acquisition of the offered opportunity will be, as well as full descriptions, photos, and other information.

As briefly mentioned above, the OAQ may be limited or unlimited. Limited OAQs may be used when there are only a limited number of available places for an offered opportunity. For example, if the opportunity 410 was associated with the purchase of one of only five new exotic sports cars that will be offered for sale total, the OAQ may be configured as a limited OAQ having only 5 available spaces (or members), where each OAQ member will be able to purchase one of the five new exotic sports cars. In this example, the top five bidders during the OAQ bidding period will end up in a ranked order from the highest token bidder to the lowest token bidder, and those five bidders will become the OAQ members and be able to go on to participate in the OAQ, where they will each be able to purchase or otherwise transact to acquire the offered opportunity (e.g., one of the five new exotic sports cars). Because the OAQ in this example is a limited OAQ, all remaining unsuccessful lower bidders in the pre-OAQ bidding period will not become OAQ Members. In embodiment, the system may implement a recirculatory utility token recycling model and the tokens committed by unsuccessful bidders may be returned to the respective unsuccessful bidders, as described in more detail below.

OAQs may be configured to support OAQ groups. For some opportunities, there may be a single OAQ group, while other opportunities may utilize multiple OAQ groups. When multiple OAQ groups are configured, OAQ members may be classified into different groups, and the different OAQ member groups may be provided with different access times and/or rights with respect to the opportunity, as described in more detail above with reference to FIG. 2.

Additionally, in embodiments, an OAQ may be configured to support structured or staged “green lighting” of OAQ participation with respect to OAQ members during the OAQ period. For example, in a staged configuration, the first place OAQ member, who was the highest token bidder during the pre-OAQ bidding period, may be green lighted (e.g., provided access to the opportunity 410) immediately upon the start of the OAQ period, the second place OAQ member may be green lighted sometime after that, and so on until all of the OAQ members have been green lighted to begin participating in the OAQ period.

As shown above, defining the opportunity 410 may include configuration of various parameters and details of the opportunity, as well as handling of various aspects of the OAQ and the access rights that are granted to members of the OAQ. It is noted that the particular parameters described herein have been provided for purposes of illustration, rather than by way of limitation, and that embodiments may utilize additional OAQ parameters and options designed to fit different kinds of offered opportunities. Accordingly, the present disclosure is not to be limited to the specific examples described herein. In an embodiment, a configured opportunity may retain the ability to be edited within specified parameters for potential delays, postponements, or other contingencies.

Once the opportunity 410 is defined, and the various parameters are configured, an OAQ record may be created via the OAQ platform. Each OAQ record may have a unique identity, will be linked to the entity that is offering the opportunity, and will contain records related to the opportunity, such as descriptions, photos, costs, requirements, conditions, limitations, and other parameters associated with the configuration of the opportunity. Additionally, it will contain the start and stop dates and times for the pre-OAQ bidding period, and the smart contract for the OAQ may be configured to automatically record when those dates and times have taken place. Each OAQ record will also state whether the OAQ is unlimited or limited, and have a corresponding structure to manage that configuration of an OAQ.

In an embodiment, when an opportunity is defined, an OAQ management module may be instantiated and an OAQ management contract may be established. The OAQ management contract may be established as a smart contract and recorded on a blockchain. In an embodiment, the OAQ management contract may be an Ethereum smart contract recorded on the Ethereum blockchain. In embodiments, a global smart contract, the OAQ management master contract, may be publicly deployed on the mainnet of a blockchain. In this manner, the OAQ management master contract may be referenced by a blockchain name service (BNS) domain. For example, if the OAQ management master contract is publicly deployed on the mainnet of Ethereum's blockchain, it may be referenced via the Ethereum Name Service (ENS), such as oaqmanagementmastercontract.ens. When an opportunity is configured by an entity, the interface may receive an input to create the opportunity, which will call a CreateQueue( )function on the master contract referenced by oaqmanagementmastercontract.ens, and this function call will in turn create a unique OAQ smart contract (e.g., the aforementioned OAQ management contract) containing all the queuing logic and parameters specified by the entity during configuration of the opportunity 410.

As described above, by placing the OAQ management master contract on the mainnet of a blockchain, it may be accessed, either directly through the blockchain or via an interface supplied by the entity operating the OAQ platform, such as an interface provided by the system 100 of FIG. 1. This enables the entity offering the opportunity 410 to instantiate an independent OAQ smart contract, such as the previously described OAQ management contract, that realizes the specific configuration specified by the entity offering the opportunity 410 (e.g., the OAQ management contract may be an instantiation of the OAQ management master contract that has been configured according to the parameters specified when the opportunity 410 was defined). In embodiments, OAQ management contract may enable any token holder capable of interacting with the appropriate blockchain (e.g., the blockchain upon which the opportunity 410's OAQ management contract is established) to participate in the opportunity 410. Additionally, token holders may participate in opportunities via an application provided by the OAQ platform and/or the entity offering the opportunity 410. In embodiments, the cost for establishing and managing smart contract on a blockchain may be calculated and paid for via OAQ setup and maintenance fees paid for by the entities offering opportunities via the OAQ platform, or may optionally be passed on in part or in whole to OAQ participants.

As described above, the OAQ management contract created for an opportunity will specify the timing for when it will accepts bids and when the bidding period closes. The OAQ management contract may include various functions that may be called to facilitate the various processes used to implement OAQ processing in accordance with embodiments. For example, after the bidding period has been completed, an opportunity OAQ manager may call a finalize( ) function, which signifies the completion of the bidding period. This will trigger functionality of the corresponding OAQ management contract to notify unsuccessful bidders. When the OAQ platform implements a recirculatory utility token recycling model, this function may also grant unsuccessful bidders with permission to withdraw their unsuccessfully bid tokens or may return the tokens to the unsuccessful bidders.

By coding the infrastructure for providing OAQs into smart contracts, the temporary storage of tokens by the OAQ platform, as well as the bidding and refunding/withdrawal logic implemented by the OAQ platform, is provably fair, automated and free of any central authorities. Alongside these features, the smart contract infrastructure adds a level of transparent auditing, as all transactions are securely time-stamped and recorded on a public ledger, such as the Ethereum blockchain.

When the scheduled pre-OAQ bidding period begins, token owners may bid tokens in hopes of becoming OAQ members with the privilege of purchasing or otherwise transactionally acquiring the offered opportunity (e.g., the ability to purchase one of five exotic cars, early access to an ICO, and the like). For example, as shown in FIG. 2, during a pre-OAQ bidding period 420, decision block 422 may determine whether the pre-OAQ bidding period for opportunity 410 is open. When decision block 422 evaluates to yes, users may submit bids to an OAQ tracking process, shown at functional block 424. In the example shown in FIG. 2, a first user has submitted one or more bids for a cumulative token total of 50 tokens, a second user has submitted one or more bids for a cumulative token total of 20 tokens, and a third user has submitted one or more bids for a cumulative token total of 10 tokens. Each of these bids is received by the OAQ tracking process, where they are evaluated to determine membership in the OAQ. In the example of FIG. 2, the OAQ has been configured to have 2 available spaces, resulting in the first user and the second user, having bid 50 and 20 tokens, respectively, being assigned as members of the OAQ, while the third user, having a bid of 10 tokens, is not assigned as a member of the OAQ.

The tokens bid by the token owners are transferred to the OAQ management contract, where they are held until the end of the pre-OAQ bidding period. For example, as shown in FIG. 2 at functional block 430, the 50 total tokens bid by the first user, the 20 total tokens bid by the second user, and the 10 tokens bid by the third users are transferred to the OAQ management contract created for the opportunity 410, where they are held until the end of the pre-OAQ bidding period. In an embodiment, OAQ records corresponding to the tokens held by the OAQ management contract may include information identifying the users to which each quantity of tokens belongs, as well as other information that may be used to identify the token owners, such as an e-mail address, telephone number, address, and the like. In embodiments, this information may be acquired during a registration process, such as when the users sign up as users of the OAQ platform to gain access to the opportunities offered via the OAQ platform.

When the pre-OAQ bidding period ends (e.g., when decision block 412 evaluates to yes), bidding will be closed and tokens are no longer able to be transferred to the OAQ management contract. At this point, the entity offering the opportunity 410 may sign and authorize the OAQ management contract to indicate the close of the pre-OAQ bidding period. In an embodiment, the signing of the OAQ management contract may enable additional steps of the method 400 to proceed. Once the OAQ bidding period ends, the bidders are sorted from highest bidders to lowest bidders and the final membership for the OAQ is decided. In embodiments where the OAQ platform implements a recirculatory utility token recycling model, the OAQ management contract defined for the opportunity 410 may simultaneously grant withdrawal permission to the users that were not assigned as members of the OAQ, allowing the tokens these unsuccessful bids to be returned to the corresponding bidders. For example, as shown at decision block 432, when the pre-OAQ bidding period has ended, processing may proceed to decision block 434, where each bid is evaluated to determine whether it was a successful bid (e.g., the bidder is assigned as a member in the OAQ) or an unsuccessful bid (e.g., the bidder is not assigned as a member of the OAQ). Where a bid was unsuccessful, such as the user's bid of 10 tokens, the tokens may be returned to the user. For example, in FIG. 2, 10 tokens are returned to the third user, as indicated at 436. In embodiments, unsuccessful bidders may be charged a fee for processing their bids, which may result in returning less tokens than were actually bid. For example, the third user may receive 9 tokens as a result of his/her unsuccessful bid, and 1 token may be retained by the system as a fee for processing the third user's bid.

Additionally, simultaneously with the conclusion of the pre-OAQ bidding period, the OAQ management contract may enable an autonomous exchange management mechanism, which may be an autonomous software agent or bot coded within the OAQ management contract and holding the private keys of wallet accounts at one or more exchanges (e.g., marketplaces where the tokens utilized by the OAQ platform may be bought and sold). The autonomous exchange management mechanism may be configured to transfer the remaining tokens that are held by the OAQ management contract (e.g., the tokens corresponding to the bids of the users assigned as members of the OAQ) to one or more of the wallets controlled by the autonomous exchange management mechanism, and, once transferred, the autonomous exchange management mechanism may interact with the exchange's APIs in order to issue a SELL Order for those tokens.

For example, as shown in FIG. 2, where decision block 434 evaluates to yes (e.g., a bid is associated with a user that is assigned as a member of the OAQ), tokens associated with successful bids may be transferred to a wallet of a token marketplace 440 (e.g., an exchange) and sell orders may be initiated. In the example shown in FIG. 2, the first user and the second user were assigned as members of the OAQ for the opportunity 410, and the 50 tokens corresponding to the first user's bid and the 20 tokens corresponding to the second user's bid are transferred to a wallet at the token marketplace 440. Once the tokens have been transferred to the wallet at the token marketplace 440, sell orders may be initiated, as shown by order processing block 450. As illustrated in FIG. 2, a first buyer may place an order to purchase 35 tokens and a second buyer may place an order to purchase 25 tokens via the token marketplace 440. The order processing block 450 may fulfill the purchases ordered by the first and second buyer via the tokens made available by the sell orders initiated by the autonomous exchange management mechanism, and the value acquired in these transactions may be transferred, at least in part, to the corresponding users. For example, the order to purchase 35 tokens may be filled from the sell order associated with the 50 tokens bid by the first user, resulting in the 35 tokens being transferred to the first buyer, as indicated at 453, and proceeds of the sale of the 35 tokens may be transferred, at least in part, to the first user, as indicated at 452.

In embodiments, the sale of tokens by the autonomous exchange management mechanism may be prioritized according to ranking of the members within the OAQ. Accordingly, after the sale of the 35 tokens, the autonomous exchange management mechanism may retain 15 tokens corresponding to the bid of the first user. These 15 tokens may be used to fulfill a portion of the order for 25 tokens, thereby completing the sale of the 50 tokens corresponding to the first user (e.g., the highest ranked member of the OAQ for the opportunity 410 due to bidding the highest quantity of tokens). Once all 50 tokens corresponding to the first user's bid have been sold, 10 tokens corresponding to the second user's bid may be used to fulfill the remaining 10 tokens purchased by the second buyer. As indicated at 454, proceeds of the sale of the 15 tokens may be transferred, at least in part, to the first user, and proceeds of the sale of the 10 tokens may be transferred, at least in part, to the second user. Additionally, the 25 tokens may be transferred to the second buyer, as indicated at 455. At decision block 444, it is determined whether the there are additional orders to fulfill, and if not, the system will continue to wait for additional orders. If decision block 444 evaluates to yes, the remaining orders are processed. For example, as shown in FIG. 2, the remaining 10 tokens corresponding to the second user's bid may be sold, as indicated at 457, to a third buyer that has submitted an order for 10 tokens to the token marketplace 440, and the proceeds of the sale of these 10 tokens may be transferred, at least in part, to the second user, as shown at 456. It is noted that in the description above, it was described that the proceeds of the sale of tokens may be transferred, at least in part, to the corresponding token owner. In embodiments, token owners may be charged a fee for handling the processing of the transactions to sell the tokens corresponding to the successful bids, resulting in less than the full amount of the proceeds being returned to the corresponding bidders. In an embodiment, when the process of selling tokens and withdrawal/disbursing of the proceeds of those sales to the respective OAQ members is completed, the OAQ management contract may be signed to signify the completion of the OAQ. From this point forward, the OAQ management contract will govern and control the OAQ itself for the opportunity 410.

As described above, the method 400 may provide a recirculatory utility token recycling model, where the tokens associated with successful bids are sold to buyers via one or more exchanges, resulting in all tokens associated with successful bids being recirculated into the marketplace. Funds received via the sale of the tokens may be transferred to the successful bidders and/or a portion of the proceeds may be retained by the OAQ platform. In embodiments, the funds may include cryptocurrencies, fiat currency, and/or other types of currency or value. In some embodiments, the sale of the tokens by the autonomous exchange management mechanism may be limited to a particular type of currency, such as a single form of cryptocurrency (e.g., Ethereum, Bitcoin, etc.). In an embodiment, the particular type of currency may be determined based upon the particular blockchain that the OAQ management contract is instantiated on. For example, where the OAQ management contract is instantiated on the Ethereum blockchain, transactions to purchase tokens corresponding to successful bids may be limited to transactions using Ethereum.

In embodiments, transferring the proceeds received from the sale of tokens corresponding to successful bids may include receiving funds of the sale in the autonomous exchange management mechanism controlled exchange wallet. These funds may be withdrawn from that wallet and transferred back into the OAQ management contract. The OAQ management module may then grant withdrawal permission to the respective OAQ members, allowing them to transfer the funds from the OAQ management contract to their own wallet. The amount of funds each OAQ member is authorized to withdraw may be determined according to the number of tokens sold on behalf of each OAQ member, and in the order of priority matching their OAQ Ranking Order of highest bidder to lowest bidder, and minus optional service fees. It is noted that implementing the final distribution and disbursement of funds to the OAQ members using a withdraw/pull pattern, in which the OAQ members must access the OAQ platform and withdraw the funds received from the proceeds of successful bid token sales, a risk of attack vectors on the platform may be significantly reduced (e.g., if a send/push pattern was used to automatically send the funds to OAQ members), thereby improving security of the OAQ platform.

Once the pre-OAQ bidding period has ended (e.g., decision block 412 evaluates to yes), OAQ membership may be finalized, and OAQ members may be provided with access to the opportunity 410, as indicated by block 414. In situations where the OAQ member access period is to be followed by an open period during which other users that were not included in the OAQ can participate in the opportunity 410, the open period may begin, as indicated by block 416, once the OAQ member access period has ended. It is noted that where an opportunity is to be limited to only members of the OAQ, block 416 may be omitted. Additionally, it is noted that although decision block 412 and decision block 432 both determine when the pre-OAQ bidding period has ended, illustration of these decision blocks in separate blocks is provided for purposes of illustration, rather than by way of limitation. In embodiments, these decision blocks may be implemented as a single logical block or process, or may be implemented as separate processes.

In embodiments, membership in an OAQ may provide the members with a special, a privileged, or a benefited category of access with respect to offered opportunities, which may also have subsequent or concurrent access opportunities available to a wider group of non-OAQ participants. In an embodiment, fees charged by the OAQ platform may also be structured to provide special levels of service or benefits for users. For entities offering opportunities via the OAQ platform, these may include upgraded notification services, enhanced customization capabilities for the OAQ interface that bidders see and interact with, and more. For bidders, this may include service upgrades, such as automatic bidding scoreboards, upgraded notifications, and the like. In embodiments, such scoreboards may be determined by tracking the number of participating bidders, as well as each bidders cumulative tokens bid, and then presenting the list of bidders in a dynamically ranked order based on the cumulative tokens bid. The list of bidders may display nicknames or pseudonames, or some system defined generic name. Enhanced scoreboard services may provide more frequent scoreboard updates. In embodiments, the frequency to which this dynamically ranked order may be provided or displayed publicly may also be a configurable parameter, including the capability to configure a first refresh rate for standard users, and one or more enhanced refresh rates for users having access to enhanced services. It is noted that the OAQ platform may track data and statistics on user activity and may maintain records, such as refresh commands, but only bids are recorded to the OAQ management contract and the blockchain. Implementing dynamic opportunity access queuing in accordance with the method 400 may aid in the amelioration of network traffic jams and overloads which have been problems for some popular ICOs to date. Additionally, as described above, the method 400 may provide additional value propositions for the tokens and its enabling system.

The method 400 may also be configured to provide various notifications associated with key steps and actions to the requisite parties. In an embodiment, the notifications may include links to the blockchain verifiable actions and transactions in the OAQ management contract, and may also include records for exchanges and distributed withdrawals/disbursements of funds/value through the sale of tokens via one or more exchanges.

As shown above, the method 400 provides a model for utilizing a blockchain token, such as an Ethereum ERC20-compliant token, in a utilitarian software mechanism (e.g., the OAQ platform) configured to provide ordered access queuing based on a recirculatory utility token recycling model, wherein utilized tokens are automatically and autonomously recycled to an exchange where they are sold/exchanged, and the proceeds routed back to or made available to the token user. The model implements notification/pull mechanisms to provide improve security, and maintains records of an instance of providing an OAQ opportunity on a blockchain to provide a system that is provably fair, automated and free of any central authorities. Alongside these features, the smart contract infrastructure adds a level of transparent auditing, as all transactions are securely time-stamped and recorded on a public ledger.

In the description above, the recirculatory utility token recycling model may be viewed as a single step recirculatory utility token recycling model. This is because the token is committed (e.g., as a bid(s) in the description above), and then the system completes its utility (e.g., determining which bidders are successful in becoming OAQ members in the description above), and then automatically and autonomously sells/exchanges the token and routes proceeds back to the token user. Such a model may be viewed as a single step recirculatory utility token recycling model because the token is used in a single step (e.g., as part of an accumulative bid) and then, if successful, recycled to the market/exchange. However, as described in more detail below, embodiments are not limited to single step recirculatory utility token recycling models.

Embodiments of the present disclosure contemplate multi-step recirculatory utility token recycling models. For example, in a long supply chain model, a party uses a token to track source, origin, contextual, or other information through a multi-step or multi-holder/handler/owner chain such that later consumers or utilizers may track components, ingredients, or source materials back to origins. At some point in this model the token may be similarly automatically and autonomously routed to an exchange and its sale/exchange proceeds routed back to the party that first utilized the token or coin within the multi-step chain. An exemplary use case for a multi-step recirculatory utility token recycling model is described below.

Suppose that a farmer has records on his farm fields, their soil profile, the seed grain he uses (e.g., a specific hybrid identity and its source data sheets, whether it has been genetically modified or not, etc.), as well as the agricultural inputs that he employs during the growing season (e.g., fertilizers, herbicides, insecticides, soil additives, etc.). The farmer may purchase or use an owned token when his fields are harvested and transported to a local grain elevator. This token records that this load(s) has come from this farmer, his specific fields (with their information) and all of the source grain and field inputs.

This individual farmer's grain may then be stored at the local grain elevator according to what method and parameters the grain elevator uses to track stored grain. A very rare grain may be stored by itself, maintaining its unique identity. But most grain will be sorted and aggregated with other grain sharing some attributes. Historically this has been rather simple, such as corn is stored with corn, soybeans are stored with soybeans, wheat is stored with wheat, etc., with these grains being subject to criteria such as moisture content and being free of mold, or other contaminants. But it may be worth keeping certified organic grain separated from non-certified organic grain, or GMO grain kept separate from non-GMO grain, and the like.

In the description that follows, individually sourced materials, such as grain, being combined will be referred to as an “aggregate source.” An aggregate source from a local grain elevator may be shipped by train or barge to a larger facility and added together with other aggregate sources to create a larger aggregate source. Each time an individual end-node source is added to another to create an aggregate source, the aggregate source inherits all the tokens representing all of the source information on what's contained in the aggregate source. At some point, there is a maximum aggregate source. In other words, no further inputs of end-node individual sources or additional aggregate sources will be added and this will constitute the maximum aggregate source. This maximum aggregate source may be divided up, but each subsequent division will have the same maximum aggregate source tokens and associated trail of source information.

At this point, the tokens may be subjected to a recirculatory utility token recycling model, where they are automatically and autonomously sent to an exchange and the proceeds routed back to or made available to the source farmers (or whomever the tokens originate in the chain from). As a maximum aggregate source is distributed, eventually down to a manufacturer where it is processed into various food products, it is possible for that end product to carry a reference to one or more aggregate sources (maximum aggregate sources), and it's possible to reconstruct the totality of source points (farm fields and inputs) that comprise these aggregate sources.

A couple of things come out of this model. One is that very large maximum aggregate sources will have a correspondingly very large amount of associated source data on location origins, field inputs, and the like. It would be simple to order and categorize maximum aggregate sources according to how large they are. Very exclusive aggregate sources may not have many end-node inputs. In fact, it would be simple to see that the ingredients in one box of cereal came from 10,436 different farms versus a box of cereal whose grain came from 4 farms. This in and of itself may constitute valuable information. In a very large aggregate source, an end user or consumer would theoretically have access to all of the information on all of the source farms, but wouldn't be able to know which specific farms produced the grain that was in their specific box. They would only be able to know the aggregate source. But this could be very valuable as well.

Automated software programs could easily sift through even very large aggregate source data files and produce reduced symbolic profiles that themselves would impart valuable or desired information about ingredients and their sources. Without having to look through every end-node in an aggregate source, a consumer could see that it had been certified (by software analysis of the aggregate source) to be 100% organic, or any other criteria. It could even say this aggregate source contains less than 1% non-organic content, according to analysis of all the aggregate source's associated data. In such a system, the tokens provide a means to track, to a very fine degree, sources as they become aggregated and provide opportunities to make the resulting data available in both fine-detail as well as provide a simplified and/or symbolic notation easy for a consumer to quickly glance at and have confidence in. This model differs from the single step model in that the token is utilized at multiple different stages (e.g., with each new aggregation).

As described above, the present application provides a new system architecture for implementing blockchain technology. It is noted that the examples described above illustrate the disclosed system architecture in the context of specific examples or use cases to which the system architecture may be applied; however, these examples or use cases have been provided for purposes of illustration, rather than by way of limitation, and the disclosed system architecture may be readily applied to numerous additional use cases. In the description that follows, additional aspects of the disclosed system architecture are described.

Existing blockchain technologies utilize a system architecture supported by miners, who provide computational resources to support the functionality of the relevant blockchain technology. For example, core blockchain technologies that support cryptocurrencies, such as Bitcoin, Ethereum, and the like, rely on entities, referred to as “miners” to provide computational resources that facilitate certain blockchain functionality. In the system architecture utilized by Bitcoin's blockchain, for instance, miners provide computational resources in order to verify transactions within a block of the blockchain with the goal of achieving consensus that transactions executed on the blockchain are correct. When a block is closed out or “mined”, a new coin or coins may be minted and provided to the miners as remuneration for the computational resources used to mine the block. As another example, Filecoin provides a decentralized storage network that runs on a blockchain and utilizes a native protocol token (e.g., the “Filecoin”). In Filecoin's decentralized storage network, miners earn Filecoins by providing storage space to Filecoin users, as well as facilitating retrieval of stored data from the decentralized storage network. As described above with respect to the miners of blockchain technologies, such as Bitcoin, Filecoin's decentralized storage network requires the computational resources of the miners to be constantly available so that users of the system may store and retrieve data. The requirement that the computational resources of the miners be constantly available increases the cost to operate as a miner. Additionally, for some blockchain technologies, additional complexity may be experienced as the size of the blockchain increases. This is because the amount of computational resources required to mine the blockchain increases as the size of the blockchain increases.

In addition to the aforementioned core blockchain-type technologies, secondary blockchain technologies have also been developed. These secondary blockchain technologies are typically built on top of existing blockchains and utilize tokens, such as ERC20 tokens issued on the Ethereum blockchain. Because these secondary blockchains are built upon existing core blockchain-type technologies, they do not utilize the same types of system architectures. For example, because the secondary blockchain technologies do not actually maintain and operate a blockchain, the do not utilize mining or miners. This may alleviate the problems associated with mining (e.g., cost, availability requirements for computational resources, etc.), but this introduces new problems that hinder the advancement of secondary blockchain technologies and their adoption by the public. For example, due to the lack of miners, an entity desiring to operate a secondary blockchain technology must provide the computational resources to facilitate the utility functions of the secondary blockchain technology. Additionally, if the secondary blockchain technology utilizes or creates new blocks on the underlying core blockchain, there is little incentive for the miners of the underlying blockchain to process transactions associated with the secondary blockchain technology (e.g., because the miners are interest in remuneration in a coin of the underlying blockchain, rather than a token of the secondary blockchain technology). For these reasons and other factors, the mining community has become centralized and is controlled by a few entities, and there is not an opportunity for smaller entities or individuals to enter the mining market. However, embodiments of the present disclosure provide a system architecture that decouples the mining process from the computational resources used to facilitate the utility functions associated with a blockchain and provides various forms of remuneration for entities that participate in the mining process provided by system architectures implemented in accordance with embodiments of the present disclosure.

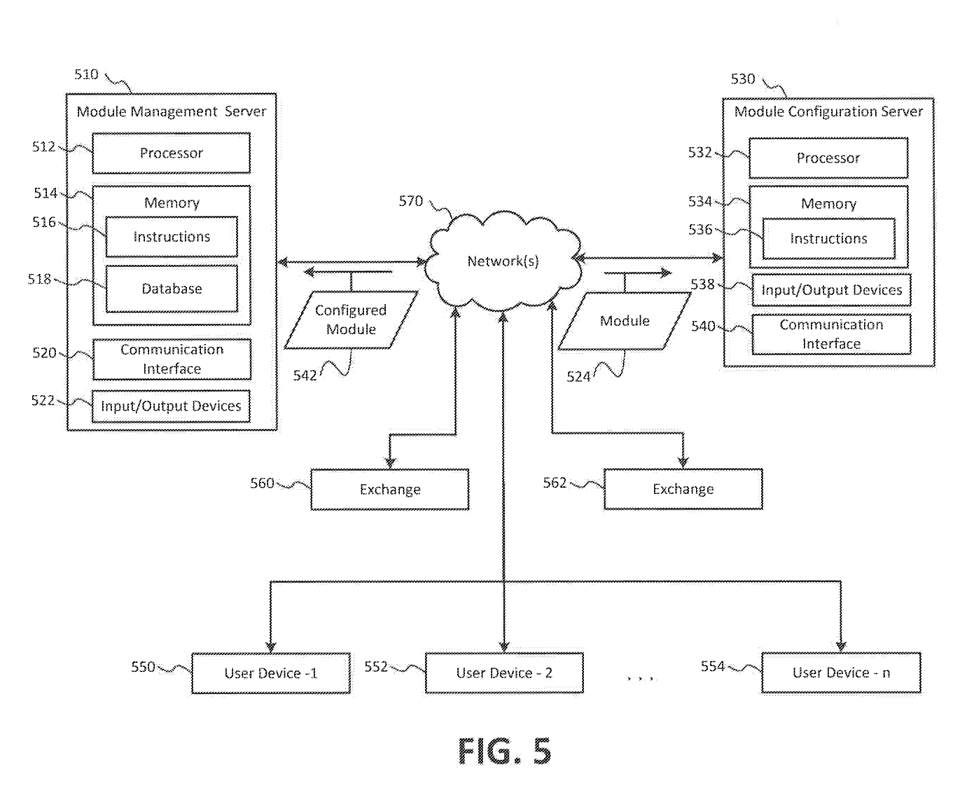

For example, and referring to FIG. 5, a block diagram illustrating additional aspects of a system architecture configured in accordance with embodiments of the present disclosure is shown as a system 500. As shown in FIG. 5, the system 500 may include a module management server 510, a module configuration server 530, a plurality of user devices (e.g., a first user device 550, a second user device 552, and an nth user device 554), one or more exchanges (e.g., a first exchange 560 and a second exchange 562), and one or more networks 570. It is noted that although FIG. 5 illustrates three user devices and two exchanges, the system 500 may be implemented with more than three user devices and/or more than two exchanges, or may be implemented with less than three user devices and/or a single exchange.

In aspects, the module management server 510 may include one or more processors 512, a memory 514, a communication interface 520, and I/O devices 522. In aspects, the memory 514 may store instructions 516 that, when executed by the one or more processors 512, cause the one or more processors 512 to perform operations for managing a dynamically ordered queue in accordance with embodiments of the present disclosure, as described in more detail below. In aspects, the memory 514 may also store a database 518. The database 518 may be stored external to one or more physical devices upon which functionality of the module management server 510 is implemented. For example, database 518 may be stored at a memory device that is accessible to the module management server 510 via a network.

The communication interface 520 may be configured to communicatively couple the module management server 510 to one or more other systems, such as the module configuration server 530, and networks according to one or more communication protocols (e.g., an IEEE 802.11 protocol, an Ethernet protocol, and the like). The I/O devices 522 may include a printer, a mouse, a keyboard, a touchscreen display device, a numeric keypad, other types of input and output devices, or a combination thereof. As described in more detail below, the module management server 510 may be configured to provide one or more services or other functionality to users in accordance with a configuration of a module (e.g., a configurable software-based service specification) that has been configured in accordance with parameters specified by an operator of the module configuration server 530. For instance, as described above in the exemplary system illustrated in FIG. 1, the queue server 110 (e.g., a module management server) may provide the host server 130 (e.g., a module configuration server) with a module that allows the operator of the host server 130 to configure parameters for providing services and/or other functionality to users associated with the plurality of user devices. Additional aspects and examples of provide a configurable module in accordance with aspects of the present disclosure are described in more detail below.

The module configuration server 530 may include one or more processors 532, a memory 534, a communication interface 540, and I/O devices 538. The memory 534 may store instructions 536 that, when executed by the one or more processors 532, cause the one or more processors 532 to perform operations for distributing an opportunity to one or more users based on a dynamically ordered queue in accordance with embodiments of the present disclosure, as described in more detail below. The memory 534 may also store a database (not shown in FIG. 5). In aspects, the database of the module configuration server 530 may be stored external to one or more physical devices upon which functionality of the module configuration server 530 is implemented. For example, the database of the module configuration server 530 may be stored at a memory device that is accessible to the module configuration server 530 via a network. The communication interface 540 may be configured to communicatively couple the module configuration server 530 to one or more other systems, such as module management server 510, and networks according to one or more communication protocols (e.g., an IEEE 802.11 protocol, an Ethernet protocol, and the like). The I/O devices 538 may include a printer, a mouse, a keyboard, a touchscreen display device, a numeric keypad, other types of input and output devices, or a combination thereof.

As shown in FIG. 5, the module configuration server 530 may receive a module 524 from the module management server 510. The module 524 may comprise a software application that is configured to provide one or more services and/or other functionality to a plurality of users, such as operators of the plurality of user devices. Upon receiving the module 524, the operator of the module management server 530 may configure various parameters of the module 524. For instance, in the exemplary implementation illustrated in FIGS. 1-4, the module 524 may be configured to facilitate the providing of an ordered access queue, and the operator of the module configuration server may configure parameters of the module 524 to specify one or more parameters associated with the scope of the ordered access queue, such as to configure parameters associated with the duration of the ordered access queue (e.g., bidding open date, bidding close date, and the like), parameters associated with the type of access provided by the ordered access queue (e.g., early access, limited access, unlimited access), parameters associated with the structure of the ordered access queue (e.g., the number of slots within the queue, a threshold quantity of tokens required to be assigned a slot with the queue, etc.), and other parameters, as described above.

In an aspect, once the module 524 has been configured, the module configuration server 524 may provide the module parameters to the module management server 510 as a configured module 524. The configured module 524 may include information that identifies the parameters that have been specified by the operator of the module configuration server 530, such as a file that specifies each of the parameters. Upon receiving the configured module 542, the module management server 510 may create an instance of the module in accordance with the parameters configured by the operator of the module configuration server 530, and the instance of the module may be accessed by the users associated with the plurality of user devices.

Creating the instance of the module may include creating a plurality of tokens, such as ERC20 tokens issued on the Ethereum blockchain. Generating the tokens using blockchain distributed ledger technology may be advantageous. For example, such an implementation would create immutable records of token ownership. The quantity of tokens issued may be specified within the parameters configured by the operator of the module configuration server 530 and may be utilized to participate in, administrate, and/or access the functionality provided by the configured module 524. A first portion of the issued tokens may be designated as available for public distribution, such as through sales via one of more of the exchanges 560, 562, and a second portion of the issued tokens may be held in reserve (e.g., for the operator of the module configuration server 530).

Once the configured module has been instantiated, the tokens may be utilized to provide services and/or other functionality in accordance with the configuration of the module, such as providing an ordered access queue or tracking items, as described above, or other operations. After the tokens have fulfilled their role in the particular service or function(s) of the configured module, an autonomous bot may return the token(s) to the market for redistribution, such as by providing the token(s) to one or more exchanges where they are sold. Proceeds of the sale of the token may be returned to the operator of the module configuration server 530. Optionally, the autonomous bot may return the token(s) to the operator of the module configuration server 530 prior to the sale of the token(s) via the one or exchanges. Periodically, the operator of the module configuration server 530 (e.g., the entity that configured the module used to provide services and/or other functionality to users) may purchase quantities of the tokens front one or more of the exchanges to facilitate further provisioning of the services and/or functionality of the configured module.

From the above-described process, referred to herein as the crypto adoption turbine (CAT) process, several advantages over existing blockchain technologies are realized. First, in system architectures implementing the CAT process described with respect to FIG. 5, the operator of the module configuration server 530 may be viewed as a new type of miner. For example, in core blockchain technologies, such as Bitcoin, miners facilitate operations to promote use of Bitcoin by providing computing resources that are used to verify transactions on the Bitcoin blockchain, and in exchange for their services (e.g., the provisioning of computing resources), the miners are remunerated with Bitcoin. Similarly to these miners, the operator of the module configuration server 530 promotes use of a crypto-asset, such as a token, by configuring a module that provides a service, and in exchange for promotion of the service, the operator is remunerated with quantities of cryptocurrency through the sale of tokens (e.g., after the tokens are used in a cycle of the CAT process associated with the service and/or functionality of the configured module. However, unlike miners in core blockchain technologies, the operator of the module configuration server 530 is not required to maintain computing resources in a perpetual state of availability, thereby decoupling the remunerative aspects of core blockchain technologies from the requirement of maintaining powerful computing resources.

It is noted that in some instances, the operator of the module configuration server may need to maintain some resources in order to provide the service and/or functionality of the configured module, however, these resources, such as a website, a database, or other types of computing resources, would typically be lower power (e.g., both in terms of power consumption and computing power) resources as compared to the very powerful computing resources utilized. by miners associated with core blockchain technologies. Accordingly, systems supporting operations of a CAT process associated with a module configured in accordance with embodiments of the present application may be operated at lower power and with reduced cost as compared to systems utilized by miners of core blockchain technologies.

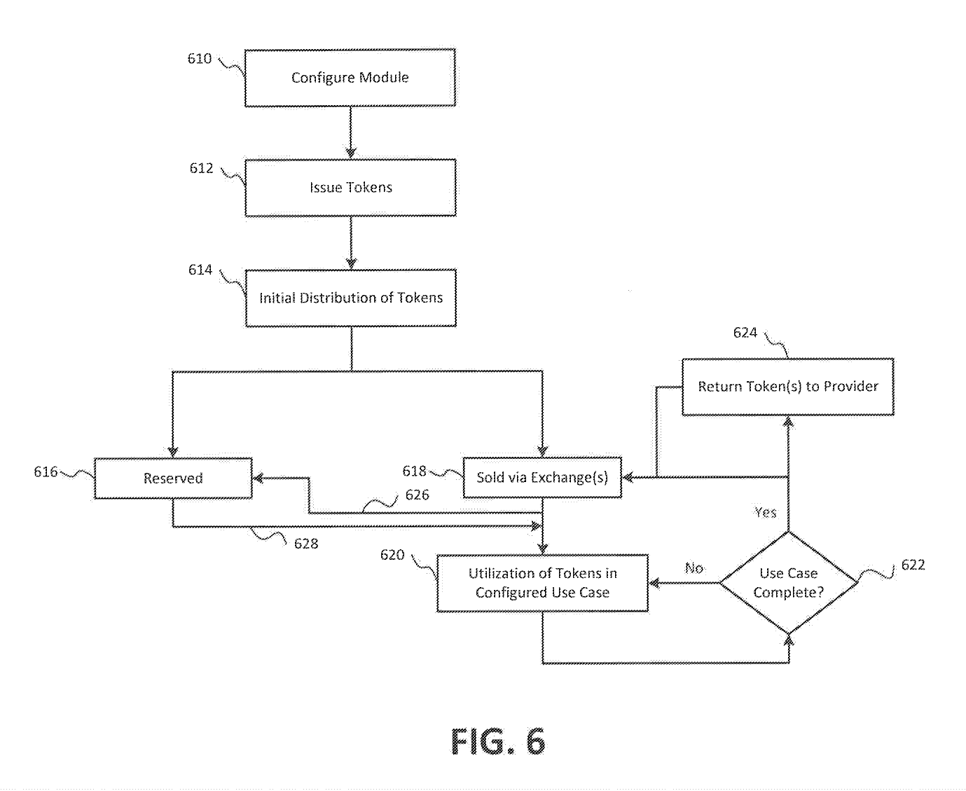

An additional advantage of the CAT process is that it promotes more rapid adoption of the tokens by the public. For example, many entities have rushed to enter the blockchain technology space and issue tokens that are offered for sale to the public; however, these tokens often struggle to gain widespread acceptance because the market for the tokens is limited. This makes it difficult to monetize the tokens. The CAT process solves this problem by providing a reliable source of demand for the tokens through the buyback process, where the entity that operates the module configuration server periodically purchases a quantity of tokens for use in further providing the services and/or functionality of the configured module. Additional aspects of a CAT process in accordance with embodiments of the present disclosure are described below with respect to FIGS. 6 and 7.

Referring to FIG. 6, a flow diagram of an embodiment of a method for implementing a CAT process in accordance with embodiments of the present disclosure is shown as a method 600. In an aspect, the method 600 may be performed by the system 100 of FIG. 1 or the system 500 of FIG. 5. Additionally, the steps of the method 600 may be stored as instructions that, when executed by one or more processors, cause the one or more processors to perform the operations of the method 600.

At 610, the method 600 includes configuring a module. As described above with reference to FIGS. 1-5, the module may facilitate provisioning of services and/or other functionality to one or more users. The one or more users may be third parties with respect to the entity that configures the module (e.g., in an OAQ use case), or may be employees, agents, or other types of users associated with the entity that configures the module (e.g., in a logistics use case).

At 612, the method 600 includes issuing a plurality of tokens. As described above, the quantity of tokens issued, at step 612, may be specified by the configuration of the module. In an aspect, the tokens may be issued as ERC20 compliant tokens on the Ethereum blockchain. In an aspect, the tokens may be issued on another blockchain, or on multiple blockchains. At 614, an initial distribution of the issued quantity of tokens may be performed. As explained above, the initial distribution of the tokens may include, at 616, issuing a first quantity of tokens to the entity that configured the module (e.g., the operator of the module configuration server 530 of FIG. 5) to hold in reserve, and at 618, selling a second quantity of tokens via one or more exchanges.

At 622, the tokens may be utilized to perform operations associated with the particular use case to which the configured module has been configured to address (e.g., an OAQ use case, a logistics use case, and the like). At 622, the method 600 includes determining whether a particular instance of the use case has been completed. For example, an instance of an OAQ use case may be completed when the OAQ is finalized, and an instance of a logistics use case may be completed when an item that has been shipped is received at the destination. If the instance of the use case has not completed, processing returns to step 620. If the instance of the use case has completed, the token(s) utilized in the completed instance of the use case may be sold, at 618, via an exchange. In an aspect, upon completion of an instance of the use case, the token may first be provided to the entity that configured the module, at 624, prior to being sold via the exchange, at 618.

As indicated at 626, the entity that configured the module may periodically purchase quantities of tokens from the exchange(s). This may be done to facilitate further utilization of the particular use case associated with the configured module and/or to replenish any tokens held in reserve. For example, as illustrated at 628, reserve tokens may be used to facilitate operations associated with instances of the configured use case, as 620. As described above, proceeds from selling tokens via the exchanges may be provided to the entity that configured the module as remuneration for promoting the use of the tokens (e.g., promoting the token both in terms of purchases at the exchange(s) as well as utilization of the tokens to facilitate instances of the particular use case).

The above-described CAT process provides many advantages that are not available in present blockchain systems and technologies. For example, the utility user (e.g., the entity that configured the module) is remunerated in a manner similar miners of core blockchain technologies; however, as explained above, by utilizing the CAT process, the utility user is not required to maintain powerful computing resources in an available state to facilitate the utility associated with the configured module. Further, the CAT process facilitates growth in the value of the tokens utilized to facilitate the utility of the token (e.g., the processes implemented by the configured module). For instance, demand for the tokens is increased because the entity that configured the module periodically repurchases quantities of tokens from the exchange(s) in order to continue providing the utility associated with the configured module. This creates an environment where the value of the token is constantly driven upwards, allowing the entity that configured the module to monetize the tokens.

To illustrate, assume that the initial quantity of tokens issued at step 612 included 100,000 tokens, where 30,000 tokens were held in reserve at step 616 and 70,000 tokens were sold via the exchange at step 618 for an initial price of $1. This means that the entity would have $30,000 held in reserve (e.g., the value of the tokens held in reserve). Now suppose that the entity purchases 20,000 tokens for facilitating the utility of the configured module and users purchased the remaining 50,000 tokens as an investment. As the tokens are used to facilitate the utility of the configured module, at step 620, those tokens will be recirculated to the exchange where they are subsequently offered for sale. Eventually, the entity would use up all 20,000 tokens and be forced to either purchase more tokens from the exchange or use the tokens held in reserve. Because the tokens are always recirculated to the exchange(s), the entity will eventually be forced to purchase additional tokens from the exchange, creating an opportunity for users that purchased the tokens as an investment to realize an increase in the value of the tokens (e.g., because the entity must obtain tokens to perform the utility operations of the configured module). Thus, the CAT process fosters growth in the value of the tokens.

At first glance, this may appear to be to the detriment of the entity, however, a closer analysis reveals that this process actually creates an additional stream of revenue for the entity. For instance, in the example above, assume that alter the initial 20,000 tokens are used up, each of the tokens has a value of $1.50 (e.g., because the users who own the remaining tokens not held in reserve set the price higher than they initially paid in order to realize a gain on their investment). This means that the entity's reserve tokens are now worth $45,000 or fifty percent (50%) more than when the tokens were issued. Thus, if the entity purchases 10,000 additional tokens from the exchange at the going price of $1.50, they are essentially using the increased value of the reserve tokens to purchase additional tokens. Suppose that after those 10,000 additional tokens are recirculated to the exchange, each token has a value of $4.00. In this scenario, the 30,000 reserve tokens would now have a value of $120,000. This cycle could continue in perpetuity with each new cycle allowing the value of the tokens to increase to the benefit of both the entity providing the utility functions of the configured module and the users that invest in the tokens. Additionally, the entity can receive further advantages by purchasing tokens from the exchange in bulk, which usually allows an entity to realize a significantly lower price than the current market rate. Further, as the tokens are sold on the exchange(s), proceeds of the sales are provided to the entity as remuneration fur providing the utility functions of the configured module. These factors foster an environment that promotes widespread adoption of the token for purposes of investment, as well as for providing the utility of the configured module. This promotes interest in the utility of the configured module, increases the value of the tokens, and enhances the longevity and adoption of the underlying blockchain, such as the Ethereum blockchain. It is noted that the above-described aspects of the CAT process have been provided for purposes of illustration, rather than by way of limitation. Additionally, it is noted that the CAT process may be implemented as a single step process or multistep process, as described in more detail below.

In a logistics use case, a module may be configured to facilitate transport of an item from a point of origin to a destination. The module may be configured to include operations for: associating a token with information identifying the item; recording information in a database in association with transport of the item (e.g., information identifying a point of origin of the item; a destination for the transport of the item; a current location of the item; one or more entities that are to handle the item during transport; a criterion for determining whether the utility of the configured module is completed, such as whether the item has reached the destination; and other parameters); updating the information recorded in the database as the item is transported from the point of origin to the destination; and providing one or more graphical user interfaces to support the utility functions associated with the configured module, such as interfaces to receive requests to ship an item, configure the item for shipment (e.g., associate the information identifying the item with a token, specify the origin and destination, specify one or more carriers to handle the transport of the item over one or more legs of the scheduled transport, etc.), facilitate tracking a current status of the shipment of the item, view items awaiting transport, or other information. It is noted that the operations described above have been provided for purposes of illustration, rather than by way of limitation, and that a CAT process according to aspects of the present disclosure may be configured to facilitate other operations in addition to, or in the alternative to the aforementioned operations. In aspects, the operations of a configured module may be specified in a smart contract written to a core blockchain, such as the Ethereum blockchain and may include operations to facilitate an autonomous bot that facilitates at least a portion of the operations, such as to recirculate tokens to the exchange following completion of a cycle of the CAT process and transferring proceeds of token sales to the entity that configured the module.

In the above-described logistics use case, when a request to transport an item is received in association with the configured module, a user of the entity that configured the module may associate information identifying the item with a token issued in connection with the configuration of the module. If the entity has no tokens available (either because they do not want to utilize reserve tokens or because all reserve tokens have been used up), additional tokens may be acquired through an exchange. Additionally, the user may configure the shipment of the item by providing information associated with: the point of origin, the destination, one or more carriers to handle the transport of the item from the point of origin to the destination, whether a signature is required upon delivery to the destination, handling instructions, or other parameters. Once the shipment is configured, the item may be scheduled to be picked up by one of the carriers from the point of origin.

Upon picking up the item at the point of origin, the carrier may scan information on the package, such as a barcode, a quick response code, and the like, or may manually enter information into an application, which may be an application associated with the configured module. When the information is scanned (or manually entered), the token may be transferred from the entity to the carrier. In an aspect, this may be the result of operations performed by the autonomous bot associated with the configured module (or may be a second autonomous bot of the configured module). By transferring the token from the entity to the carrier, an immutable record of the transfer of possession of the item may be created on the blockchain. As the item is transported, each carrier that handles the item may follow similar procedures, and each change of possession of the item may be recorded by transferring the token to the new carrier. Finally, the item may be delivered to the destination, at which point the autonomous bot may transfer the token to an exchange where it is offered for sale. In an aspect, the token may be transferred back to the entity prior to offering the token for sale at the exchange. For example, upon receiving the token following delivery to the destination, the record(s) associated with the transport of the item may be updated to reflect that the item has been successfully delivered. Proceeds of the sale of the token may be provided to the entity as remuneration for facilitating the utility functions of the token. It is noted that the carrier may be associated with or part of the entity that configured the module, or may be a third party logistics provider that was hired by the entity to facilitate the transport of the item.

In an aspect, one or more signatures may be obtained during the transport of the item. For example, when a first carrier takes possession of the item, he may provide a digital signature to authenticate taking possession of the item, and each subsequent change in possession may also involve at least one party providing a digital signature to authenticate the change in possession. In some aspects, multi-signature transactions may also be utilized. For example, upon delivering the item to the destination, the carrier may provide a digital signature to signify delivery to the destination, and the recipient of the item may also provide a digital signature verifying receipt of the item. In an aspect, the recipient may be able to provide notes at the time the digital signature is provided, such as to indicate that the item was damaged during shipment. Other parties involved in the transport of the item may also be able to provide notes at the time they take possession of the item or when they transfer possession of the item to another party. In this manner, when a second carrier receives the item in a damaged state, the second carrier can note that the item was damaged prior to the second carrier taking possession of the item. This information may be logged by the configured module, and in some instances, may initiate further operations, such as to recall the shipment and/or initiate a second shipment of the item as a replacement for the damaged item. In the use case described above, a multi-step CAT process was described. However, it is noted that CAT processes in accordance with embodiments may also be implemented as single-step processes.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
instantiating, by one or more processors, a queue comprising a finite number of queuing slots configured to provide prioritized access to a host system;
receiving, by the one or more processors from devices associated with a plurality of requesting users, a plurality of queuing requests, each queuing request comprising information that identifies a quantity of tokens;
allocating, by the one or more processors, at least a portion of the finite number of queuing slots to at least a portion of the requesting users according to the quantity of tokens identified by each queuing request; and
authorizing, by the one or more processors, access to the host system in accordance with the allocation of the finite number of queuing slots.

2. The method of claim 1, the allocating includes:
determining whether a quantity of tokens identified in each received queuing request satisfies a threshold quantity of tokens; and
allocating one queuing slot of the finite number of queuing slots to each requesting user associated with a queuing request that identifies a quantity of tokens that satisfies the threshold quantity of tokens, wherein requesting users associated with queuing requests that do not satisfy the threshold quantity of tokens are not allocated one of the finite number of queuing slots.

3. The method of claim 2, wherein the threshold quantity of tokens is associated with a variable quantity of tokens, and wherein the variable quantity of tokens increases over time.

4. The method of claim 3, wherein the threshold quantity of tokens varies during a queuing period corresponding to a period of time designated for receiving queuing requests from the plurality of users.

5. The method of claim 2, further comprising reallocating at least one of the finite number of queuing slots from a first requesting user to a second requesting user in response to a determination that the second requesting user is associated with a queuing request that identifies a second quantity of tokens that greater than a first quantity of tokens identified in a queuing request associated with the first user.

6. The method of claim 5, wherein the first user is removed from queue in response to the reallocating, the method further comprising:
transmitting a first notification to the first user, the first notification indicating that the first user has been removed from the queue; and
transmitting a second notification to the second user, the second notification indicating that the second user has been allocated to one of the finite number of queuing slots of the queue.

7. The method of claim 1, wherein prioritized access to the host system is provided to each of the requesting users allocated to one of the finite number of queuing slots during a first period of time, the method further comprising providing all users with access to the host system during a second period of time that is subsequent to the first period of time.

8. The method of claim 7, wherein the host system comprises an e-commerce platform, and wherein access to the host system by the requesting users authorizes the requesting users to purchase at least one offering from the e-commerce platform, the at least one offering comprising at least one of a digital asset, a physical product, and a service.

9. The method of claim 8, further comprising reserving a threshold quantity of the at least one offering for acquisition by the requesting users during the first period of time.

10. The method of claim 9, further comprising reserving a remaining quantity of the at least one offering for acquisition by all users during the second period of time.

11. The method of claim 1, wherein the host system comprises a content distribution network, and wherein prioritized access to the host system by the requesting users allocated to one of the finite number of queuing slots provides a higher quality of service than is provided to other users provided with access to the host system.

12. The method of claim 1, further comprising grouping the requesting users allocated slots within the queue into one or more subgroups, wherein authorizing access to the host system is further based on the grouping of the requesting users.

13. The method of claim 1, further comprising, upon receiving the plurality of queuing requests comprising information that identifies a quantity of tokens, placing the quantity of tokens in escrow account for each user associated with a request, said escrow account having rules associated with actions to be taken on the respective tokens upon the allocation of the finite number of queuing slots.

14. The method of claim 13 further comprising, upon a first requesting user receiving an allocated slot, placing the quantity of tokens identified by the first requesting user for sale on an open token market.

15. The method of claim 13 further comprising, upon a first and second requesting users receiving an allocated slot, placing the quantity of tokens identified by the first and second requesting users for sale on an open token market, wherein priority for the sale of the tokens of the first and second users is governed by an assigned priority to the respective users.

16. The method of claim 13 further comprising upon a first requesting not user receiving an allocated slot, releasing the quantity of tokens from the escrow account back to the first requesting user.

17. A method comprising:
instantiating, by one or more processors, a queue comprising a finite number of queuing slots configured to provide prioritized access to a host system;
receiving, by the one or more processors from devices associated with a plurality of requesting users, a plurality of queuing requests, each queuing request comprising information that identifies a quantity of tokens;
allocating, by the one or more processors, at least a portion of the finite number of queuing slots to at least a portion of the requesting users according to the quantity of tokens identified by each queuing request;
authorizing, by the one or more processors, access to the host system in accordance with the allocation of the finite number of queuing slots; and
initiating, by the one or more processors, operations to sell at least a portion of the tokens identified by queuing requests of users corresponding to slots in the allocation of the finite number of queuing slots.

18. The method of claim 17, wherein initiating operations to sell at least the portion of the tokens identified by the queuing requests of the users corresponding to the slots in the allocation of the finite number of queuing slots comprises:
transferring at least the portion of the tokens to a wallet at a token marketplace; and
initiating at least one order to sell a quantity of tokens transferred to the wallet via the token marketplace; and
transferring at least a portion of funds received from the sale of the quantity of tokens to one or more users corresponding to slots in the allocation of the finite number of queuing slots.
